(19) United States
(12) Patent Application Publication
(10) Pub. No.: US 2025/0157117 A1
(43) Pub. Date: May 15, 2025

(54) TECHNIQUES FOR MOTION EDITING FOR CHARACTER ANIMATIONS

(71) Applicant: AUTODESK, INC., San Francisco, CA (US)

(72) Inventors: Qian ZHOU, Toronto (CA); Fraser ANDERSON, Newmarket (CA); George William FITZMAURICE, Toronto (CA); David Ledo MAIRA, Toronto (CA)

(21) Appl. No.: 18/916,485

(22) Filed: Oct. 15, 2024

Related U.S. Application Data
(60) Provisional application No. 63/597,652, filed on Nov. 9, 2023.

(51) Int. Cl. G06T 13/40; G06T 19/00

(52) U.S. Cl. CPC G06T 13/40; G06T 19/006; G06T 2200/24

(57) ABSTRACT

A technique for modifying character animations via a user interface, including displaying a timeline that includes frame numbers as time units, displaying a set of keyposes of the character along the timeline based on a set of frame numbers associated with the set of keyposes, displaying a set of trajectories that is superimposed on the set of keyposes, wherein each trajectory in the set of trajectories is displayed as a curve that passes through a particular joint of the character across the set of keyposes, and receiving a modification of a first keypose included in the set of keyposes via the user interface. A technique for automatically extracting a set of keyposes from a character animation based on the plurality of joint trajectories. A technique for retiming segments of a character animation.

### CROSS-REFERENCE TO RELATED APPLICATIONS

The present application claims the benefit of U.S. Provisional Application titled, “TECHNIQUES FOR INTEGRATING SPATIAL AND TEMPORAL MOTION EDITING FOR CHARACTER ANIMATION IN VIRTUAL REALITY,” filed on Nov. 9, 2023, and having Ser. No. 63/597,652. The subject matter of this related application is hereby incorporated herein by reference.

### BACKGROUND

### Field of the Various Embodiments

The various embodiments relate generally to computer science and, more specifically, to techniques for motion editing for character animations.

### Description of the Related Art

Three-dimensional (3D) animation is being implemented more frequently across a variety of applications as authoring tools for animation motion capture become more computationally inexpensive and technically simpler to use. For example, animated 3D characters are becoming increasingly prevalent in online videos, video games, and virtual environments. In this regard, motion capture techniques have become far more accessible to both sophisticated and non-expert users, who can now create character animations using widely available motion capture devices, such as cameras, monocular videos, sensors on virtual-reality (VR) headsets. With these types of devices, users can readily generate a character animation that includes a set of frames, where each frame includes motion capture data that specifies a particular pose of a character. The character pose typically changes across the set of frames to produce an animation clip of the character. After the character animation has been created, the character animation can be edited/modified via an animation editing application that is used to edit/modify the spatial data and temporal data associated with the character animation via spatial controls and temporal controls provided in either a desktop-based user interface or a VR-based user interface.

Despite the fact that motion capture techniques and related devices have made creating/authoring character animations easier for users, conventional editing applications that are used to edit the resulting character animations remain non-intuitive and difficult to learn for non-expert users. For example, in many editing applications, the spatial controls and temporal controls for editing the spatial data and temporal data are not integrated/embedded in the same area of the user interface. Instead, these controls are implemented separately within the user interface in a disconnected manner. Accordingly, when editing a character animation, a user typically has to first interact with spatial controls, such as a configurable 3D model of the character, to edit the spatial aspects of the character animation, and then has to separately interact with disconnected temporal controls, such as a configurable animation timeline, to separately edit the temporal aspects of the character animation. As a result, to modify the motion of the character through a segment of the animation, a user has to continually alternate between the spatial view of the 3D model and the temporal view of the animation timeline to modify multiple frames of the animation. In addition, non-expert users oftentimes have difficulty achieving an overall desired motion of a character because editing applications usually do not indicate how changes made to the 3D model in a current frame impact the 3D models in adjacent frames along the animation timeline, and non-expert users do not have enough experience to understand what changes are needed to the 3D models in adjacent frames along the animation timeline to effectively create the overall desired motion of the character.

Another drawback of conventional editing applications is that these applications usually do not provide any way to automatically extract keyposes from a character animation for editing. More specifically, a given character animation can include a vast number of different character poses for the various characters in the character animation. However, a large portion of those character poses are typically “non-essential poses,” such as static poses or near-static poses, that oftentimes are not important when editing a character animation. Instead, a relatively small subset of the character poses in a character animation are considered to be essential “keyposes,” such as transitioning poses between static or near-static poses, that are representative of the overall motion in a character animation. Editing the keyposes included in a character animation is usually more effective and efficient relative to editing the non-essential poses of the character animation as well in changing the overall motion of the character animation. However, with most editing applications, a user requires a certain level of expertise to accurately extract the relevant keyposes of a character animation, and typically results in erroneous identification of keyposes for non-expert users, which reduces the effectiveness of editing such keyposes.

A further drawback of conventional editing applications is that these applications do not provide an easy and intuitive way for novice users to retime a particular segment of the character animation. In addition to modifying a pose in a character animation, another common editing task performed by users is the retiming of a segment of the character animation. In this editing task, the user wishes to slow down or speed up the motion of the character in a particular segment of the character animation. Conventionally, to slow down the motion of the character in the particular segment, the user can add new frames to the particular segment. In contrast, to speed up the motion of the character in the particular segment the user can remove frames from the particular segment. However, the user requires expertise in knowing where to add the new frames or remove the current frames within the retimed segment to provide a smooth and natural motion of the character within the retimed segment. Non-expert users performing such retiming operations with conventional editing applications will typically not be able to accurately add and remove frames to provide a smooth and natural motion of the character within the retimed segment, thus degrading the quality of the character animation.

As the foregoing illustrates, what is needed in the art are more effective techniques for editing character animations.

### SUMMARY

Various embodiments include a computer-implemented method for modifying character animations via a user interface. The computer-implemented method includes displaying a timeline that includes frame numbers as time units, displaying a set of keyposes of the character along the timeline based on a set of frame numbers associated with the set of keyposes, displaying a set of trajectories that is superimposed on the set of keyposes, wherein each trajectory in the set of trajectories is displayed as a curve that passes through a particular joint of the character across the set of keyposes, and receiving a modification of a first keypose included in the set of keyposes via the user interface.

At least one technical advantage of the disclosed techniques relative to the prior art is that the disclosed techniques enable spatial controls and temporal controls for editing character animations to be integrated and located together within a 3D timeline user interface (UI) of an animation editing application. The 3D timeline UI simultaneously displays a set of keyposes and a set of trajectories that are superimposed onto an animation timeline. Each displayed trajectory passes through a particular joint of a character across the set of keyposes to help users visualize the character motion that occurs in the different poses that occur between the keyposes. The user can modify a current keypose displayed along the animation timeline and, in response, the 3D timeline UI automatically propagates corresponding changes to the poses located near the keypose and indicates the corresponding changes via an updated set of trajectories that help users visualize the modified motion of the character along the animation timeline. With this functionality, the 3D timeline UI simplifies animation editing for non-expert users relative to prior art approaches by not requiring the user to continually alternate between the spatial controls/view of the poses and the temporal controls/view of the animation timeline to modify the motion of the character animation. In addition, when changes are made to a current keypose, the 3D timeline UI automatically indicates resulting changes made to nearby poses via the updated trajectories so that users do not have to accurately predict how changes to one pose impact nearby poses, as required in prior art approaches. In this manner, the disclosed techniques provide an approachable and intuitive interface that enables non-expert users to more easily and efficiently edit character animations relative to conventional editing applications. These technical advantages provide one or more technological improvements over prior art approaches.

Various embodiments include a computer-implemented method for automatically extracting sets of keyposes from character animations. The computer-implemented method includes determining a plurality of trajectories for a plurality of joints associated with a character included in a character animation, wherein each trajectory includes a set of positions for a corresponding joint included in the plurality of joints across a set of poses of the character in the character animation, extracting the set of keyposes from the character animation based on the plurality of trajectories, and displaying the set of keyposes within a user interface for further processing.

At least one technical advantage of the disclosed techniques relative to the prior art is that the disclosed techniques enable an animation editing application to automatically and accurately extract a set of keyposes from a character animation, something that was not achievable using prior art approaches. Accordingly, the disclosed techniques avoid a non-expert user inaccurately selecting a set of keyposes from the character animation. In particular, the disclosed techniques enable the animation editing application to extract a set of keyposes that accurately represents the motion of the character animation based on the trajectories of multiple joints of the character through the various poses of the character animation. Automatically identifying and extracting a set of keyposes that accurately represents a character animation can also increase the overall accuracy and quality of the edits made to the character animation. These technical advantages provide one or more technological improvements over prior art approaches.

Various embodiments include a computer-implemented method for retiming segments included in character animations. The computer-implemented method includes displaying a set of keyposes associated with a character animation along an animation timeline, receiving a selection of a plurality of keyposes included in the set of keyposes, the plurality of keyposes defining a selected segment included in the character animation, receiving a command to expand or contract the selected segment along the animation timeline, wherein the command specifies an updated segment, and executing one or more retiming operations on the selected segment to generate the updated segment.

At least one technical advantage of the disclosed techniques relative to the prior art is that the disclosed techniques enable a retiming function in an animation editing application that can be automatically applied to a selected segment of a character animation to slow down or speed up the motion of the character in the selected segment, something that was not achievable using prior art approaches. In operation, a user expands or contracts the selected segment to specify an updated segment. In response, the retiming function automatically generates a speed curve function based on the amount of expansion or contraction and applies the speed curve function to the selected segment to add new frames or remove frames from the selected segment to automatically generate an updated segment, where the character within the updated segment has a smooth and natural motion. In this manner, the disclosed techniques provide a retiming function that allows both expert and non-expert users to more accurately and efficiently retime a segment of a given character animation to improve the quality of the character animation relative to what can be achieved using prior art approaches. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 is a screenshot of the 3D timeline UI of FIG. 1, according to various embodiments;

FIG. 3 is a screenshot of a selected joint associated with a current keypose included in the 3D timeline UI of FIG. 2, according to various embodiments;

FIG. 4 is a screenshot of a modification to the selected joint of FIG. 3, according to various embodiments;

FIGS. 5A-5B set forth a flow diagram of method steps for editing a character animation via a 3D timeline UI, according to various embodiments;

FIG. 6 sets forth a flow diagram of method steps for displaying visual representations of active trajectory datasets within a 3D timeline UI, according to various embodiments;

FIG. 7 sets forth a flow diagram of method steps for automatically extracting a set of keyposes from a character animation, according to various embodiments;

FIG. 8 is a screenshot of the 3D timeline UI of FIG. 1 showing a retiming function element, according to various embodiments;

FIG. 9 is a screenshot of the 3D timeline UI of FIG. 8 showing an activated retiming function element, according to various other embodiments;

FIG. 10 is a screenshot of the 3D timeline UI of FIG. 9 showing an expanded segment, according to various other embodiments;

FIG. 11 is a screenshot of the 3D timeline UI of FIG. 9 showing a contracted segment, according to various other embodiments;

FIG. 12 sets forth a flow diagram of method steps for retiming a selected segment of a character animation, according to various embodiments;

FIG. 13 illustrates a speed curve for an expanded updated segment implemented via a retiming function, according to various embodiments; and

FIG. 14 illustrates a speed curve for a contracted updated segment implemented via a retiming function, according to various embodiments.

### DETAILED DESCRIPTION

In the following description, numerous specific details are set forth to provide a more thorough understanding of the various embodiments. However, it will be apparent to one of skilled in the art that the inventive concepts can be practiced without one or more of these specific details.

As used herein, a “trajectory” is associated with a particular joint of a character in a character animation comprising a set of poses of the character depicted a set of frames. A trajectory for a particular joint comprises a dataset that includes a set of joint positions (3D spatial coordinates) of the particular joint across the set of poses in the set of frames of the character animation. The set of joint positions of the trajectory are time ordered based on a frame number corresponding to each joint positions. A representation of a trajectory for the particular joint can be displayed on the 3D timeline UI as a 3D curve that passes through the particular joint across each keypose of the character animation that is also displayed in the 3D timeline UI to help users visualize the motion of the character that occurs between keyposes.

As used herein, a “set of keyposes” of a character in a character animation comprises a subset of all poses of the character in the character animation that is representative of an overall motion of the character in the character animation. The remaining subset of poses in the character animation can be referred to as “a set of non-essential poses” or “a set of non-keyposes.” The set of keyposes are extracted/identified from the character animation to depict the overall motion of the character in the character animation in a concise view and highlights the important poses within the character animation. A frame that includes a keypose can be referred to as a “keyframe.” The set of keyposes is extracted/identified from the character animation based on one or more trajectories of one or more joints of the character. In some embodiments, the set of keyposes is extracted/identified from the character animation based on a plurality of trajectories corresponding to a plurality of selected joints of the character.

As used herein, an “IE interface” comprises 3D-specific hardware and software components for interacting with a 3D immersive environment (IE). For example, 3D hardware can include a 3D display, one or more 3D controllers that operate in 3D, one or more tracking devices, and one or more cameras. For example, 3D software can include a 3D timeline UI engine that generates an immersive 3D timeline UI on a 3D display. Examples of IE interfaces include a virtual-reality (VR) interface and an augmented-reality (AR) interface.

The disclosed techniques enable a 3D timeline UI in an animation editing application to integrate spatial controls and temporal controls for editing a character animation of a character. A character animation comprises a set of poses of the character that includes a set of non-essential poses and a set of keyposes that is representative of the overall motion of the character in the character animation. The 3D timeline UI displays an animation timeline comprising a time axis having frame numbers as time units. The 3D timeline UI also displays the set of keyposes that are superimposed/overlaid at locations on the animation timeline based on the frame numbers of the animation timeline and the frame numbers associated with the set of keyposes. The 3D timeline UI also displays a set of trajectories that are superimposed/overlaid onto the set of keyposes based on a set of joints of the character. Each displayed trajectory comprises a continuous curve that passes through a particular joint of the character across the set of keyposes to help users visualize the passage of time and the motion of the character that occurs in the poses between the keyposes. The user can directly edit a current keypose displayed in the 3D timeline UI. In response, the 3D timeline UI automatically propagates corresponding changes to one or more poses nearby the current keypose and automatically updates the set of trajectories based on the changes to the current keypose and the nearby poses. The 3D timeline UI also automatically displays the updated set of trajectories to indicate the changes to the current keypose and the nearby poses to help users visualize the updated motion of the character that occurs in the poses between the keyposes. The changes to the current keypose and the nearby poses generate a modified character animation that can be stored and further modified based on user edits.

The disclosed techniques also enable an animation editing application to automatically extract a set of keyposes from a character animation. The set of keyposes are automatically extracted from the character animation based on a set of joint trajectories associated with the character animation. The animation editing application initially generates a trajectory for each joint of the character. A trajectory for a particular joint comprises a dataset comprising a set of ordered positions of the particular joint across all poses in all frames of the character animation. The set of positions of the trajectory are time ordered based on frame numbers corresponding to the set of positions. The animation editing application can generate and store a trajectory dataset for each joint of the character. The animation editing application then receives a selection of a plurality of joints of the character (either by default or by the user) and retrieves a plurality of selected trajectories corresponding to the plurality of selected joints. The animation editing application then extracts/identifies a set of keyposes from the character animation based on the plurality of selected trajectories. The user can also select a new plurality of joints of the character via a joint map, which causes the animation editing application to dynamically identify a new set of keyposes for the character animation based on the new plurality of selected joints. The animation editing application also displays the set of keyposes, whereby the user can select and directly edit a keypose among the set of keyposes to modify the character animation.

The disclosed techniques further enable a retiming function in an animation editing application that is applied to a selected segment of a character animation to slow down or speed up the motion of the character in the selected segment. A 3D timeline UI of the animation editing application displays an animation timeline comprising a time axis having frame numbers as time units. The 3D timeline UI also displays the set of keyposes that are superimposed onto the animation timeline, each keypose being superimposed onto the animation timeline at the frame number corresponding to the particular keypose. The user can select a segment of the character animation by selecting a pair of keyposes displayed in the 3D timeline UI, the selected pair of keyposes defining a selected segment. The user can then expand (increase) or contract (decrease) the frame distance along the animation timeline between the selected pair of keyposes to slow down or speed up, respectively, the motion of the character in the selected segment. Expanding or contracting the selected segment along the animation timeline specifies an updated segment. In response, the animation editing application automatically executes one or more retiming operations on the selected segment based on a degree of the expansion or contraction of the selected segment along the animation timeline. In particular, the 3D timeline UI automatically generates a speed curve function based on the amount of expansion or contraction which is automatically applied to the poses/frames of the selected segment to provide a slow down or speed up of the motion of the character in an updated segment in a smooth and natural manner.

### System Overview

Generally speaking, a two-dimensional (2D) computing environment is provided by a computing device that executes a 2D application implemented via a 2D interface, such as a desktop environment implemented via a desktop interface. In contrast, a three-dimensional (3D) immersive environment (IE) is provided by a computing device that executes a 3D application implemented via an IE interface, such as a virtual-reality (VR) or augmented-reality (AR) environment implemented via a VR or AR interface, respectively. Performing animation editing via a 3D environment and IE interface can give the user a better sense of space and scale and improve productivity relative performing animation editing via to a 2D environment and 2D interface. In the embodiments described below, the animation editing application can be implemented in a 3D environment via an IE interface.

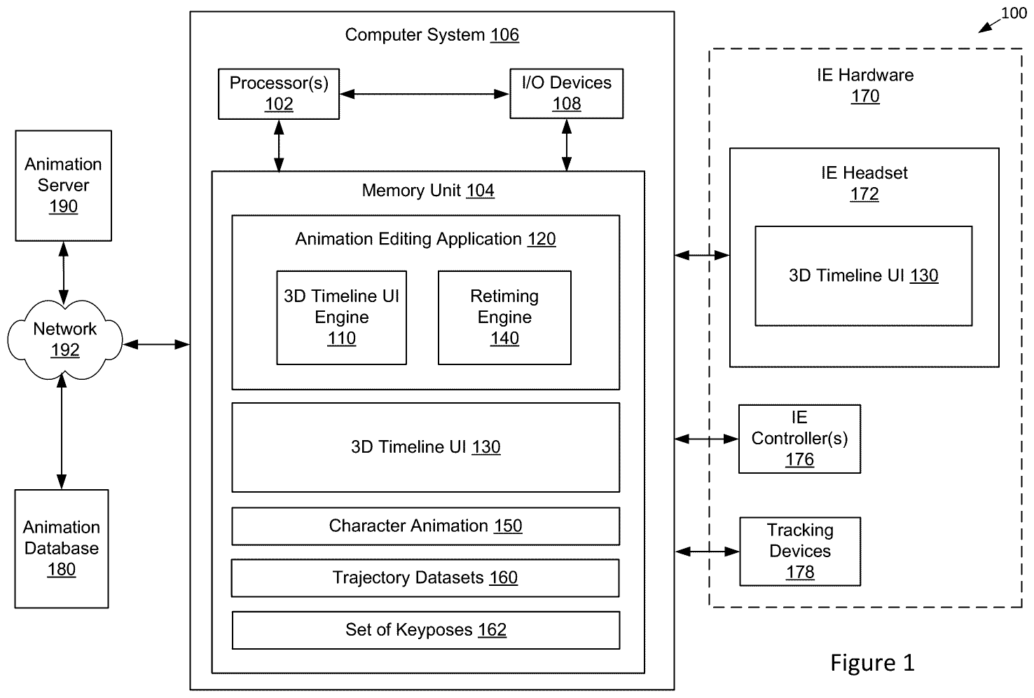

FIG. 1 illustrates a system 100 configured to implement one or more aspects of the various embodiments. As shown, the IE system 100 includes, without limitation, a computer system 106, an animation database 180, and an animation server 190 interconnected via a network 192, which may be a wide area network (WAN) such as the Internet, a local area network (LAN), or any other suitable network. An animation server 190 can comprise computer hardware (such as a processor, memory, and storage device) for executing animation-editing support services when requested by the computer system 106, such as frame interpolation. The animation database 180 can store various character animations that can be loaded to the computer system 106 for editing, in accordance with the embodiments described herein.

The computer system 106 can comprise at least one processor 102, input/output (I/O) devices 108, and a memory unit 104 coupled together. The computer system 106 can comprise a server, personal computer, laptop or tablet computer, mobile computer system, or any other device suitable for practicing various embodiments described herein. For example, the computer system 106 can comprise a cloud server to provide animation editing as a cloud service to other computer systems on the network 192. In general, each processor 102 can be any technically feasible processing device or hardware unit capable of processing data and executing software applications and program code. Each processor 102 executes the software and performs the functions and operations set forth in the embodiments described herein. For example, the processor(s) 102 can comprise general-purpose processors (such as a central processing unit), special-purpose processors (such as a graphics processing unit), application-specific processors, field-programmable gate arrays, or other programmable logic device, discrete gate or transistor logic, discrete hardware components, or any combination of different processing units.

The memory unit 104 can include a hard disk, a random access memory (RAM) module, a flash memory unit, or any other type of memory unit or combination thereof. Processor 102 and I/O devices 108 read data from and write data to memory 104. The memory unit 104 stores software application(s) and data. Instructions from the software constructs within the memory unit 104 are executed by processors 102 to enable the inventive operations and functions described herein.

I/O devices 108 are also coupled to memory 104 and can include devices capable of receiving input as well as devices capable of providing output. The I/O devices 108 can include input and output devices not specifically listed in the IE hardware 170, such as a network card for connecting with a network 192, a speaker, a fabrication device (such as a 3D printer), and so forth. Additionally, I/O devices can include devices capable of both receiving input and providing output, such as a touchscreen, a universal serial bus (USB) port, and so forth.

As shown, the computer system 106 is also connected to various IE hardware 170 including, without limitation, an IE headset 172, one or more IE controllers 176, and one or more tracking devices 178. Each IE controller 176 comprises an IE-tracked device that is tracked by the tracking devices 178 that determine 3D position/location information for the IE controller 176. For example, the IE controller 176 can comprise a 6-Degree of Freedom (6DOF) controller that operates in 3D. The IE headset 172 can display images in 3D stereo images, such as a 3D timeline UI 130. The IE headset 172 comprises an IE-tracked device that is tracked by the tracking devices 178 that can determine 3D position/location information for the IE headset 172. In some embodiments, the tracking devices 178 track a 3D position of a user viewpoint by tracking the 3D position of the IE headset 172. In some embodiments, the IE hardware 170 comprises VR hardware 170 including, without limitation, a VR headset 172, one or more VR controllers 176, and one or more VR tracking devices 178. In other embodiments, the IE hardware 170 comprises AR hardware 170 including, without limitation, an AR headset 172, one or more AR controllers 176, and one or more AR tracking devices 178. In further embodiments, the IE hardware 170 comprises other types of IE hardware used to display and interact with other types of 3D immersive environments.

The memory unit 104 stores an animation editing application 120, a 3D timeline UI 130, a character animation 150, a plurality of trajectory datasets 160, and a set of keyposes 162. The animation editing application 120 includes a 3D timeline UI engine 110 and a retiming engine 140. Although shown as separate software components, the 3D timeline UI engine 110 and retiming engine 140 can be integrated into a single software component. For example, in other embodiments, the retiming engine 140 can be integrated with the 3D timeline UI engine 110. In further embodiments, the animation editing application 120 can be stored and executed on the IE Headset 172.

The animation editing application 120 (as stored in the memory unit 104 and executed by the processor 102 of FIG. 1) includes the 3D timeline UI engine 110 for generating the 3D timeline UI 130 which is displayed in the IE headset 172. The 3D timeline UI engine 110 also provides the underlying functionality of the 3D timeline UI 130 described herein. The 3D timeline UI 130 can comprise a 3D virtual environment with which the user can interact via the IE controllers 176. For example, the user can directly edit keyposes displayed in the 3D timeline UI 130 via the IE controllers 176. The animation editing application 120 also includes the retiming engine 110 for executing a retiming function. The animation editing application 120 performs operations on the character animation 150 that can be, for example, downloaded from the animation database 180. The character animation 150 can be captured, for example, using a vision system (such as a color camera or depth camera) that captures frame by frame motion capture data of a character. The animation editing application 120 performs operations on the character animation 150 to generate the plurality of trajectory datasets 160 and the set of keyposes 162.

The character animation 150 comprises a source file that includes frames of motion capture data for an animation clip of a character, each frame having an associated frame number indicating its time order within the character animation 150. The character animation 150 comprises a temporal spatial dataset that includes a plurality of frames (representing a temporal aspect of the animation), each frame containing metadata specifying a particular pose of the character (representing a spatial aspect of the animation). In particular, each frame specifies a 3D model of the character that is configured in a particular pose. The 3D model of the character can include a plurality of joints that are organized and connected in a tree-hierarchy data structure. The 3D model can comprise a set of kinematic joints forming a kinematic chain, so that a position and/or rotation modification to one joint can cause position and/or rotation modifications to be propagated to one or more other joints in the set of kinematic joints. As such, the joints of the 3D model can have a dependency on each other and be interrelated in terms of position and/or rotation. The 3D model of the character can comprise, for example, a skeleton rig, joint frame, articulated characters, non-rigged characters, and the like.

A joint of a character can be any predetermined portion/point on the character that can be used as an effector, including points typically considered a “joint” (such as a right elbow, right shoulder, left knee, and the like). However, a joint of a character can be a predetermined portion/point (such as key vertices) on the character that is not typically considered a “joint” (such as a forehead, right eye, left ear, right forearm, and the like). In addition, a character can be any type of 3D object, including a humanoid (human-like) object or a non-humanoid object, such as an animal, car, airplane, boat, and the like. Thus, for non-humanoid objects, a joint of the character can be any predetermined portion/point on the character, such as an emblem on a car, a steering wheel of a car, a particular window on an airplane, and the like.

Each frame of the character animation 150 specifies metadata for each joint of the character, including the position and rotation of each of joint in the frame. The position of a joint can be expressed in 3D spatial coordinates (xyz coordinates) in the local coordinate system of the 3D model. The rotation of the joint can be expressed in 3 rotation values relative to the 3 axes (xyz axes) of possible rotation. The character animation 150 can also include metadata describing the joints of the character, the total number of joints of the character, and how the joints are organized and connected in the tree hierarchy data structure.

The animation editing application 120 performs operations on the character animation 150 to generate the trajectory datasets 160, which include a trajectory dataset for each joint of the character. In particular, the animation editing application 120 processes the character animation 150 to extract, for each joint of the character, the 3D position of the joint in each pose/frame of the character animation 150. Thus, a trajectory dataset for a joint comprises a set of ordered 3D positions of the joint across the set of poses/frames of the character animation, the set of 3D positions being sequentially time ordered based on frame numbers corresponding to the set of 3D positions.

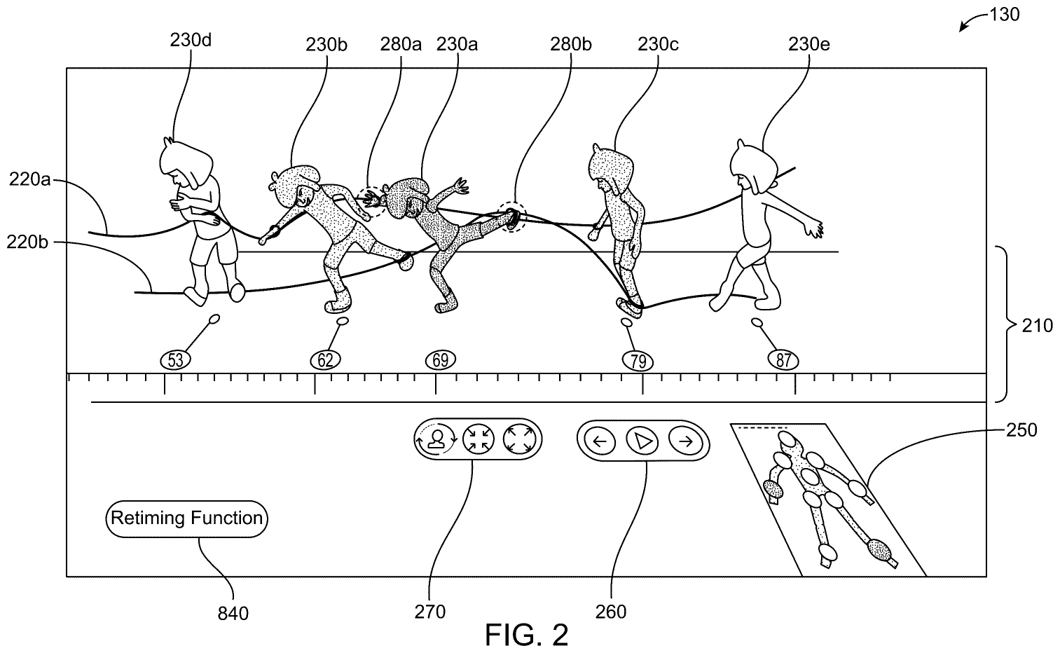

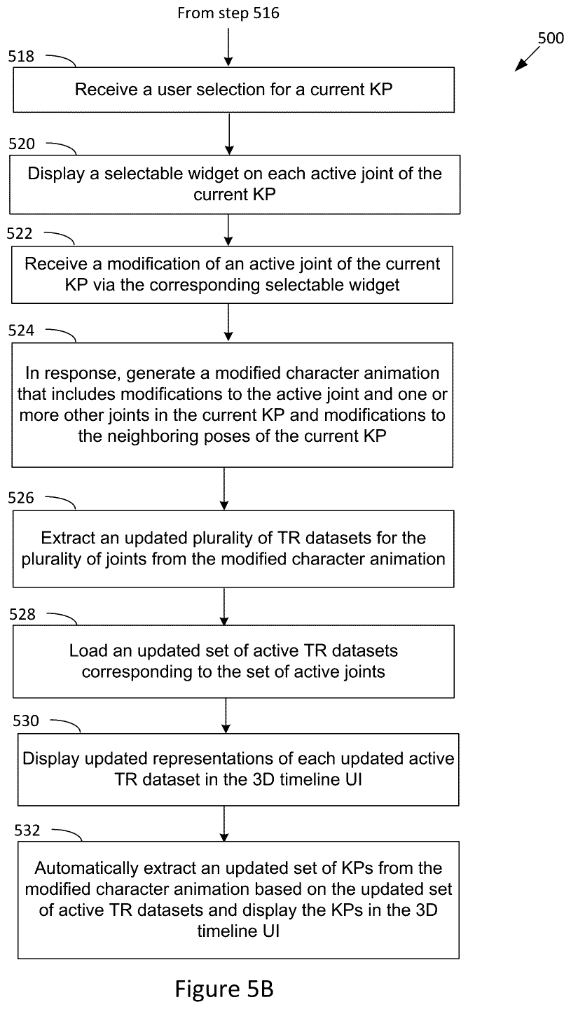

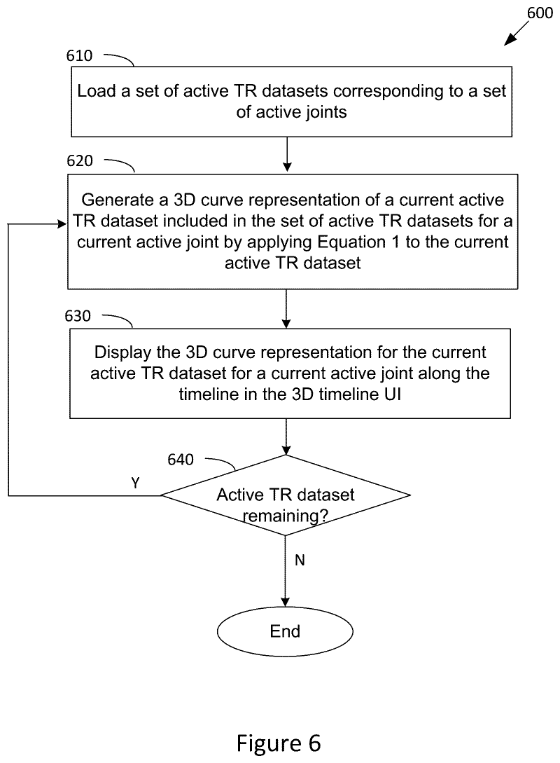

The animation editing application 120 can then display representations of the trajectory datasets 160 in the 3D timeline UI 130 as 3D curves using a trajectory display technique described below in relation to FIG. 6 and Equation 1. In some embodiments, to avoid visual clutter, only some but not all of the trajectory datasets 160 are displayed in the 3D timeline UI 130 as 3D curves, and only “active” trajectory datasets for “active” joints are displayed in the 3D timeline UI 130. Active joints can be selected by default by the animation editing application 120 or by the user via a joint map. In some embodiments, the active joints comprise a subset of all joints of the character. In some embodiments, a plurality of active trajectory datasets for a plurality of active joints are displayed in the 3D timeline UI 130. In addition, the animation editing application 120 can automatically extract/identify the set of keyposes 162 from the character animation 150 based on a set of active trajectory datasets using a keypose extraction technique described below in relation to FIG. 7 and Equations 2-3. The set of keyposes 162 is also displayed in the 3D timeline UI 130, whereby the active trajectories for the active joint are superimposed onto the set of keyposes 162. As described below in relation to FIG. 2, the 3D timeline UI 130 also displays a timeline having a time axis having frame numbers as time units. The 3D timeline UI 130 is displayed on the IE headset 172.

Animation Editing within a 3D Timeline UI

FIG. 2 is a screenshot of the 3D timeline UI 130 of FIG. 1, according to various embodiments. The 3D timeline UI 130 is generated based on a humanoid character of a character animation 150 that depicts the motion of the humanoid character while dancing. As shown, the 3D timeline UI 130 displays a animation timeline 210, one or more continuous curve representations of active trajectories 220 (such as 220a and 220b) for one or more active joints of the character, one or more keyposes 230 (such as 230a, 230b, 230c, etc.) of the character animation, a joint map 250, playback control buttons 260, view control buttons 270, and a selectable retiming button 840 (discussed in the section below relating to the retiming function). In some embodiments, the animation timeline 210, one or more curve representations of active trajectories 220, and the one or more keyposes 230 are simultaneously displayed in the 3D timeline UI 130 concurrently at overlapping times.

The animation timeline 210 includes a time axis (shown horizontally along the x axis) having frame numbers as time units. In some embodiments, the animation timeline 210 displays a frame number for each keypose 230 along the animation timeline 210 and does not display a frame number for any non-keypose along the animation timeline 210. In some embodiments, each displayed frame number for a keypose 230 comprises a selectable frame number for navigating to and selecting the corresponding keypose 230. For example, in response to receiving a selection of a first selectable frame number corresponding to a first keypose 230a, the animation editing application 120 can navigate to the first keypose 230a on the animation timeline 210 and select the first keypose 230a for editing.

In the example of FIG. 2, the active joints include a right wrist joint and a left ankle joint of the character. The joint map 250 displays a visualization of all the joints of the character (such as 10 joints in total) arranged in a tree-hierarchy structure that displays the organization of the joints and the relationships between the joints (such as parent-child relationships). The joints of the character can comprise a set of kinematic joints. The joint map 250 visually represents each joint as a selectable circle in the joint tree hierarchy, whereby dark circles represent selected/active joints and light circles represent non-selected/non-active joints.

As shown, the joint map 250 indicates that the right wrist joint and the left ankle joint of the character are selected as active joints. In some embodiments, the 3D timeline UI 130 does not display representations of trajectories for all joints of the character and only displays representations of active trajectories for active joints of the character. As such, the representations of active trajectories 220 include a representation of a first active trajectory 220a for the right wrist joint and a representation of a second active trajectory 220b for the left ankle joint of the character. The 3D timeline UI 130 displays the representations of the active trajectories 220 as 3D animation curves using a trajectory display technique described below in relation to FIG. 6 and Equation 1. The active trajectories 220 are displayed along the animation timeline 210 based on the frame numbers of the animation timeline 210 and the frame numbers associated with the active trajectories 220. Each active trajectory 220 illustrates the 3D position (xyz coordinates) of the corresponding active joint along the animation timeline 210.

The keyposes 230 of the character are superimposed/overlaid onto the animation timeline 210 and displayed along the animation timeline 210 based on the frame numbers of the animation timeline 210 and the frame numbers associated with the keyposes 230. In particular, the 3D models of the keyposes 230 of the character are displayed along the animation timeline 210. Note that the curve representations of the active trajectories 220 are simultaneously/concurrently superimposed onto the keyposes 230, wherein each trajectory 220 is displayed as a 3D curve that passes through a particular joint of the character across all the keyposes 230. For example, the representation of the first active trajectory 220a is displayed as a first 3D curve that passes through the right wrist joint of the character across all the keyposes 230 and the representation of the second active trajectory 220b is displayed as a second 3D curve that passes through the left ankle joint of the character across all the keyposes 230.

Each keypose 230 is displayed along the animation timeline 210 at a frame number corresponding to a frame in the character animation 150 that includes the keypose 230. The frame number corresponding to each keypose 230 is also prominently displayed on the animation timeline 210 (for example, shown as a frame number inside a selectable circle button). In some embodiments, only the frame numbers corresponding to the keyposes 230 are displayed on the animation timeline 210, while frame numbers corresponding to non-essential poses (non-keyposes) are not displayed on the animation timeline 210. As shown, the displayed keyposes 230 include a current keypose 230a, a pair of adjacent keyposes (keypose 230b and keypose 230c) that are keyposes adjacent to the current keypose 230 on both sides of the current keypose 230 on the animation timeline 210, and a pair of next adjacent keyposes (keypose 230d and keypose 230e) that are next adjacent keyposes to the current keypose 230 on both sides of the current keypose 230 on the animation timeline 210. In particular, the pair of adjacent keyposes include one keypose 230b that is adjacent to the current keypose 230a on a first side of the current keypose 230a, and another keypose 230c that is adjacent to the current keypose 230a on a second side of the current keypose 230a along the animation timeline 210.

A current keypose 230a is a keypose that is currently selected by the user and displayed towards the center of the 3D timeline UI 130. In some embodiments, the current keypose 230a is displayed with a different visual characteristics/appearance than the other non-current keyposes 230. For example, the current keypose 230a can be displayed with a highlighted appearance and the other non-current keyposes 230 are displayed with a non-highlighted appearance. In some embodiments, the other non-current keyposes 230 are displayed with a particular visual appearance based on a frame distance from the current keypose 230a. For example, the current keypose 230a can be displayed with a first appearance, the adjacent pair of keyposes 230 that are adjacent to the current keypose 230 on both sides (such as keypose 230b and keypose 230c) can be displayed with a second appearance, and the next-adjacent pair of keyposes 230 that are next adjacent to the current keypose 230a on both sides (such as keypose 230d and keypose 230e) can be displayed with a third appearance, and so forth, whereby the first appearance, second appearance, and the third appearance are each different visual appearances. For example, the current keypose 230a can be displayed in a dark shaded color (first appearance), the adjacent pair of keyposes 230 can be displayed in a light shaded color (second appearance), and the next-adjacent pair of keyposes 230 can be displayed in an outline form (third appearance), as shown in FIG. 2.

The animation editing application 120 can automatically extract/identify the keyposes 230 from the character animation 150 based on the active trajectories 220 using a keypose extraction technique described below in relation to FIG. 7 and Equations 2-3. Each identified keypose 230 is then rendered and displayed in the 3D timeline UI 130 using the metadata describing the identified keypose 230 stored in the corresponding frame. In particular, the 3D model of each identified keypose 230 rendered and displayed in the 3D timeline UI 130 using the metadata describing the 3D model stored in the corresponding frame. Each keypose 230 can be identified via the frame number of the frame that includes the keypose 230, whereby a list of frame numbers identifying the keyposes 230 can be stored to the set of keyposes 162. In some embodiments, the set of keyposes 162 can also store the metadata needed for rendering and displaying each keypose 230.

Active joints can be selected by default by the animation editing application 120 or by the user via the joint map 250, which in turn determines which trajectories 220 are active and will be displayed in the 3D timeline UI 130. Which trajectories 220 are active will also determine which poses are identified as keyposes 230 in the character animation 150 and displayed int the 3D timeline UI 130. The joint map 250 allows users to focus on specific joint movements by activating only the joints and trajectories of interest to the user, and then viewing the keyposes that are generated by the active joints and trajectories. In this regard, the user can select a new set of active joints via the joint map 250, which in response, causes the animation editing application 120 to dynamically determine a new set of active trajectories 220 corresponding to the new set of active joints, and determine a new set of keyposes 230 in the character animation 150 based on the new set of active trajectories 220, whereby the 3D timeline UI 130 dynamically displays the new set of active trajectories 220 and the new set of keyposes 230.

The playback control buttons 260 include selectable buttons for navigating the frames of the character animation 150 along the animation timeline 210. The playback control buttons 260 include a play/pause button, a forward button, and a reverse button. Selection of the play button causes the character animation 150 to be played back. In some embodiments, during playback, the keyposes 230 are not displayed to avoid visual cluttering, whereby the keyposes 230 are displayed when the animation is paused. In some embodiments, the active trajectories 220 are displayed both during playback and when the animation is paused. The forward and reverse buttons can be selected to navigate to a next frame or previous frame, respectively, of the character animation 150 along the animation timeline 210. Also, each keypose 230 has a frame number displayed inside a selectable circle button along the animation timeline 210, wherein selecting the circle button will navigate to the selected keypose 230 (thus making the selected keypose 230 the current keypose 230).

The view control buttons 270 include a rotation button, zoom-in button, and zoom-out button. The rotation button enables the user to rotate displayed keyposes 230 in place, providing the user with a view of the motion in the character animation 150 from various angles. The zoom-in button and zoom-out button allows a user to adjust the number of frames that are visible in the 3D timeline UI 130. The zoom-in button decreases the number of frames that are visible in the 3D timeline UI 130 to allow the user to focus on a smaller number of frames. The zoom-out button increases the number of frames that are visible in the 3D timeline UI 130 to allow the user to view a broader range of frames.

In the example of FIG. 2, the animation timeline 210 includes a time axis (shown horizontally along the x axis) having frame numbers as time units, so that the difference in horizontal position between the keyposes 230 indicates the number of non-essential poses between the keyposes 230. Note that while the horizontal time axis at a bottom portion of the animation timeline 210 serves as a reference of time, a top portion of the animation timeline 210 designates a 3D spatial coordinate area where 3D models of the keyposes 230 are displayed. In other embodiments, the animation timeline 210 can be configured to be plotted and displayed along the y axis or z axis instead of the x axis. In the example of FIG. 2, the animation timeline 210 has a straight linear shape which can be appropriate for short to medium length character animations 150. However, the straight linear shape of the animation timeline 210 may not be ideal for relatively longer character animations 150 as the user can find it difficult to reach keyposes far from the current keypose. In other embodiments, the animation timeline 210 can have a different type of shape, such as a curved, circular, or spiral shape for visualizing the character animations 150. These different types of shapes can be more ideal for relatively longer character animations 150 and enable the user to more easily reach keyposes far from the current keypose.

After the keyposes 230 are displayed in the 3D timeline UI 130, the user can navigate through the keyposes 230 of the character animation 150 along the animation timeline 210 and select particular keyposes 230 for editing. A currently selected keypose 230 is referred to as the current keypose 230a. Upon receiving a user selection of a current keypose 230a, in response, the 3D timeline UI 130 displays a selectable widget 280 (such as 280a and 280b) on each active joint of the current keypose 230a. In the example of FIG. 2, the 3D timeline UI 130 displays a first widget 280a on a right wrist joint of the current keypose 230a and a second widget 280b on a left ankle joint of the current keypose 230a. The selectable widgets 280 enable a user to manipulate 3D models of keyposes 230 by directly manipulating the joints of the 3D models, for example, via the IE controllers 176. Advantageously, IE controllers 176 leverage the 6-Degree of Freedom (6DOF) input and hand-tracking to make manipulation of 3D models easier for the user.

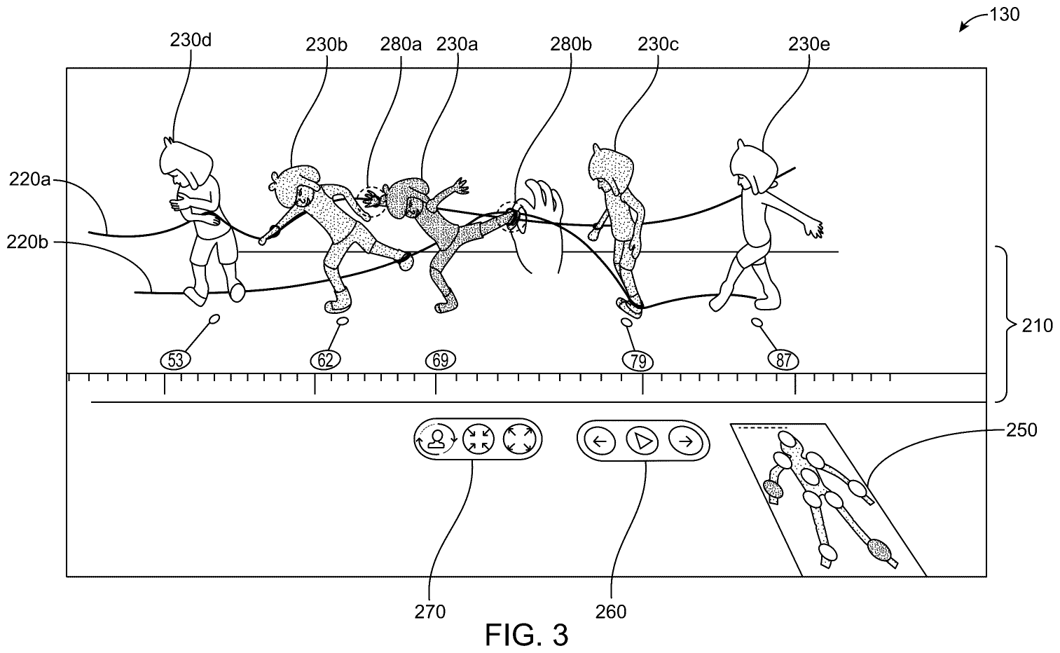

FIG. 3 is a screenshot of a selected joint associated with a current keypose included in the 3D timeline UI of FIG. 2, according to various embodiments. As shown, a user selection is received for a left ankle joint of the current keypose 230a, for example, via the IE controllers 176. The user can then use the second widget 280b on the left ankle joint to modify the left ankle joint on the current keypose 230a. A selectable widget 280 on a particular joint can be selected by the user to modify the 3D position and/or rotation of the particular joint. In some embodiments, a selectable widget 280 comprises a spherical widget comprising a center point and 3 axes (xyz axes) of rotation, each axis being displayed in a different color (such as blue, green, and red). The user can move the selectable widget 280 to a new 3D position to modify the current 3D position of the corresponding joint. The user can rotate the selectable widget 280 around one or more axes to a new rotation to modify the current rotation of the corresponding joint.

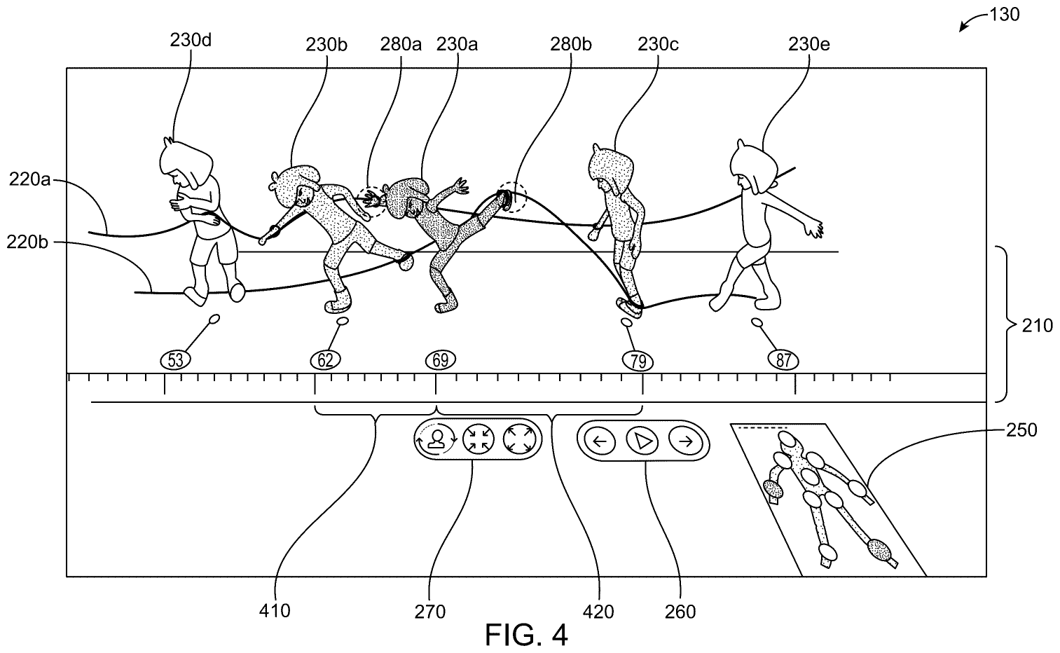

FIG. 4 is a screenshot of a modification to the selected joint of FIG. 3, according to various embodiments. As shown, the user has modified the 3D position of the left ankle joint via the second widget 280b by changing the initial 3D position of the left ankle joint shown in FIG. 3 to an updated 3D position of the left ankle joint shown in FIG. 4. In response to the user modifications/changes performed on the selected left ankle joint, the animation editing application 120 executes a series of operations including propagating the modifications to other joints in the current keypose 230a, propagating the modifications to the current keypose 230a to other poses nearby the current keypose 230a, saving the modified character animation 150, updating all trajectory datasets 160 for the modified character animation 150, updating the representations of the active trajectories 220 displayed in the 3D timeline UI 130 based on the updated trajectory datasets 160, re-extracting the set of keyposes 162 from the updated character animation 150 based on the updated active trajectories 220, and updating the rendered keyposes 230 displayed in the 3D timeline UI 130

As discussed above, the 3D model of the character can comprise a set of kinematic joints forming a kinematic chain, so that a position and/or rotation modification to one joint can cause position and/or rotation modifications to be propagated to one or more other joints in the set of kinematic joints. Therefore, any modifications of a particular joint in the current keypose 230a can cause the modifications to be propagated to the other joints in the current keypose 230a, the extent of the modifications propagated to the other joints depending on the extent of the modifications to the particular joint and the kinematic characteristics of the kinematic chain (skeleton rig) of the character. The position and/or rotation modifications propagated to the other joints can be computed using various solvers, such as an inverse kinematic solver or other type of solver.

The modifications to the selected joint and one or more other joints in the current keypose 230a are then propagated to other poses nearby the current keypose 230a in the character animation 150. Each keypose is included in a keyframe and the current keypose is included in a current keyframe of the character animation 150. In some embodiments, the modifications to the joints made in a current keypose in a current keyframe are propagated to all non-essential poses included in frames neighboring the current frame as bounded by a pair of just adjacent keyposes 230, these non-essential poses that are modified being referred to as “neighboring” poses. In these embodiments, the neighboring poses/frames that are modified based on the modifications to a current keypose/keyframe comprise all poses/frames between the current keypose/keyframe and an adjacent previous keypose/keyframe and all poses/frames between the current keypose/keyframe and an adjacent next keypose/keyframe the character animation 150 and as displayed along the animation timeline 210.

In the example of FIG. 4, the current keypose 230a has been modified, whereby the modifications are propagated to a first set of poses 410 between the current keypose 230a and the adjacent previous keypose 230b and a second set of poses 420 between the current keypose 230a and the adjacent next keypose 230c as displayed along the animation timeline 210. In this manner, propagating effects of the modifications to the current keypose 230a can be contained to a limited range of neighboring poses/frames. In other embodiments, the pair of keyposes 230 that bound the neighboring poses/frames can be selected by the user to extend the range of poses/frames that are modified that are modified based on the modifications to a current keypose/keyframe.

In some embodiments, positional and/or rotational modifications to a current keypose/keyframe propagated to neighboring poses/frames using weighted linear interpolation and weighted spherical interpolation. The weighted linear interpolation can be used to propagate the positional modifications to the joints in the current keypose to the joints in the neighboring poses and the weighted spherical interpolation can be used to propagate the rotation modifications to the joints in the current keypose to the joints in the neighboring poses. The weights can be determined using a Gaussian distribution, with the peak centered on the current keypose/keyframe at which the modifications occurred. Thus, the peak/highest weight is at the current keypose/keyframe and the weights for the neighboring poses/frames decrease the farther away (in frames/time) a neighboring pose/frame is from the current keypose/keyframe. As such, the most amount of propagated modification occurs at the neighboring poses/frames closest (in frames/time) to the current keypose/keyframe and the least amount of propagated modification occurs at the neighboring poses/frames farthest (in frames/time) to the current keypose/keyframe. In the example of FIG. 4, the most amount of propagated modification occurs at the neighboring poses closest to the current keypose 230a on both sides and the least amount of propagated modification occurs at the neighboring poses/frames closest to the adjacent previous keypose 230b and the adjacent next keypose 230c.

As one or more poses/frames in the character animation 150 have now been modified, a modified character animation 150 has been generated and the animation editing application 120 then stores the modified character animation 150 to memory 104. As the trajectories of one or more joints in the character animation 150 has been modified, the animation editing application 120 also recomputes and updates all trajectory datasets 160 for all joints in the modified character animation 150. Each trajectory dataset for a joint comprises a set of time ordered positions of the joint across all poses/frames of the character animation, as discussed above in relation to FIG. 1.

The animation editing application 120 can then retrieve updated active trajectory datasets 220 from the updated trajectory datasets 160 and display representations of the updated active trajectory datasets 220 in the 3D timeline UI 130 as 3D curves. In the example of FIG. 4, the active joints are still the right wrist joint and the left ankle joint, so the animation editing application 120 retrieves an updated first active trajectory 220a for the right wrist joint and an updated second active trajectory 220b for the left ankle joint and redisplays updated representations of the updated first active trajectory 220a and the updated second active trajectory 220b as 3D curves.

As discussed above, the set of keyposes 162 are identified based on one or more active trajectories for one or more active joints. Since the active trajectories 220 have been updated in the trajectory datasets 160, the animation editing application 120 also re-extracts the set of keyposes 162 based on the updated active trajectories 220. The animation editing application 120 also re-renders and redisplays the newly extracted keyposes 230 in the 3D timeline UI 130.

The above-described process can be performed by the animation editing application 120 for each user modification received for a joint of the current keypose 230a. Advantageously, the user can immediately see the effects a modification to a joint has in the spatial realm through the displayed changes to the 3D model of the current keypose 230a and in the temporal realm through the displayed changes to the representative 3D curves of the active trajectories 220 across the active joints of the keyposes 230 along the animation timeline 210. In this manner, the user can easily modify keyposes in the character animation 150 and review the resulting changes to the character animation 150 in an intuitive and efficient manner via the 3D timeline UI 130.

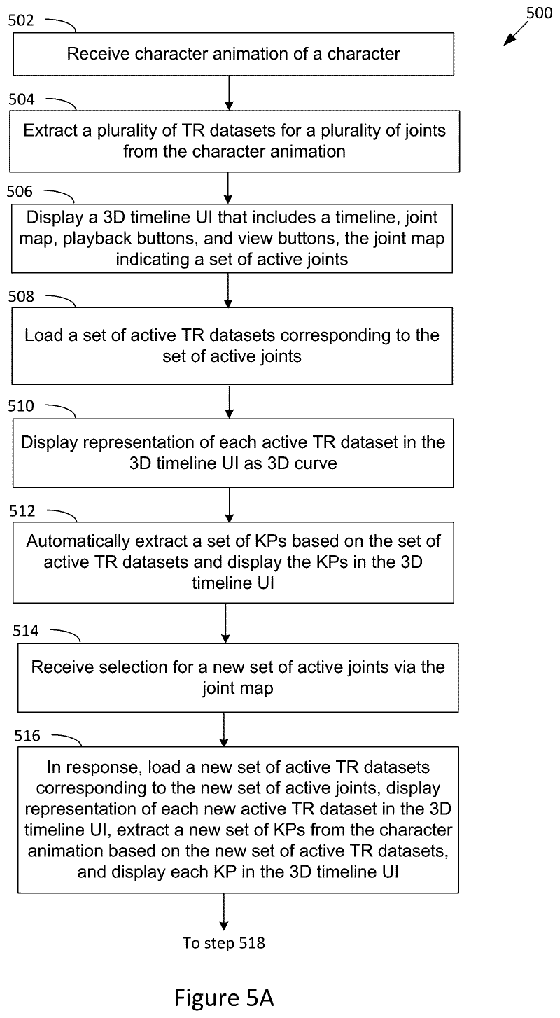

FIGS. 5A-5B set forth a flow diagram of method steps for editing a character animation via a 3D timeline UI, according to various embodiments. Although the method steps are described in conjunction with the systems of FIGS. 1-4, persons skilled in the art will understand that the method steps can be performed in any order by any system. In some embodiments, the method 500 can be performed by the animation editing application 120 that includes the 3D timeline UI engine 110.

The method 500 begins when the animation editing application 120 receives (at step 502) a receives a source file that includes a character animation 150 comprising a plurality of frames of motion capture data for a plurality of poses of a character, each frame having an associated frame number indicating its time ordering within the character animation 150. Each frame captures a specific pose of the character. In particular, each frame includes metadata that specifies a pose of a 3D model of the character comprising a plurality of joints organized in a tree hierarchy. For example, the character animation 150 can be downloaded from the animation database 180 and stored to memory 104.

At step 504, the animation editing application 120 extracts a plurality of trajectory datasets 160 for the plurality of joints from the character animation 150, each trajectory dataset corresponding to a particular joint of the character. Each trajectory dataset for a joint includes a plurality of ordered 3D positions of the joint across the plurality of poses/frames of the character animation 150, the plurality of 3D positions being sequentially time ordered based on frame numbers corresponding to the plurality of 3D positions. The plurality of extracted trajectory datasets 160 can stored to memory 104.

At step 506, the animation editing application 120 generates and displays a 3D timeline UI 130 that includes an animation timeline 210, a joint map 250, playback control buttons 260, and view control buttons 270, as shown in the example of FIG. 2. The animation timeline 210 includes a time axis having frame numbers as time units. The joint map 250 displays a visualization of all the joints of the character and the relationships between the joints. The joint map 250 also indicates which joints are “active” joints. A set of active joints can be selected by default by the animation editing application 120 or by the user via a joint map. The playback control buttons 260 include selectable buttons for navigating the frames of the character animation 150 along the animation timeline 210. The view control buttons 270 include a rotation button, zoom-in button, and zoom-out button.

At step 508, the animation editing application 120 loads a set of active trajectory datasets 220 corresponding to the set of active joints from the plurality of trajectory datasets 160. In some embodiments, the set of active joints comprises a plurality of active joints and the set of active trajectory datasets 220 comprises a plurality of active trajectory datasets 220. In some embodiments, the set of active joints comprises some but not all of the plurality of joints of the character and the set of active trajectory datasets 220 comprises some but not all of the plurality of trajectory datasets 160.

At step 510, the animation editing application 120 displays a representation of each active trajectory dataset 220 in the 3D timeline UI 130 as a 3D curve using a trajectory display technique described below in relation to FIG. 6 and Equation 1. At step 512, the animation editing application 120 automatically extracts/identifies a set of keyposes 162 from the character animation 150 based on the set of active trajectory datasets 220 using a keypose extraction technique described below in relation to FIG. 7 and Equations 2-3. The identified keyposes 230 are also displayed in the 3D timeline UI 130. In some embodiments, each keypose 230 is superimposed on the animation timeline 210 and displayed at a location on the animation timeline 210 based on a frame number associated with the keypose 230. In some embodiments, the curve representations of the active trajectory datasets 220 are superimposed onto the displayed keyposes 230 to help users visualize the motion of the character that occurs in the poses between the displayed keyposes 230. In addition, the animation timeline 210 includes a selectable frame number adjacent/underneath to each keypose 230, the selectable frame number corresponding to a frame number of a frame in the character animation 150 that includes the keypose 230.

At step 514, the animation editing application 120 receives a user selection for a new/different set of active joints via the joint map 250. At step 516, in response to receiving the selection of the new/different set of active joints, the animation editing application 120 loads a new/different set of active trajectory datasets 220 corresponding to the new/different set of active joints from the plurality of trajectory datasets 160, displays representations of each new/different active trajectory dataset 220 in the 3D timeline UI 130, extracts a new/different set of keyposes 162 from the character animation 150 based on the new/different set of active trajectory datasets 220 and displays each keypose 230 in the 3D timeline UI 130. In this manner, the animation editing application 120 can dynamically display active trajectory datasets 220 and keyposes 230 in the 3D timeline UI 130 in response to user selections of new/different active joints via the joint map 250. Note that the animation editing application 120 can dynamically repeat steps 514-516 each time the user selects new/different active joints via the joint map 250.

At step 518, the animation editing application 120 receives a user selection for a particular keypose 230 displayed along the animation timeline 210, the selected keypose 230 being referred to as a current keypose 230a. For example, the user can navigate to the current keypose 230a using the playback control buttons 260 and select the current keypose 230a, or the user can select the frame number displayed underneath the current keypose 230a on the animation timeline 210 to select the current keypose 230a. In response, at step 520, the animation editing application 120 displays a selectable widget 280 on each active joint of the current keypose 230a in the 3D timeline UI 130.

At step 522, the animation editing application 120 receives a user modification of an active joint of the current keypose 230a via the corresponding selectable widget 280. The received modification can comprise a position or rotation modification of the active joint. In response to receiving the user modification at step 522, the animation editing application 120 performs the below steps 524-530.

At step 524, the animation editing application 120 modifies the character animation 150 to generate a modified character animation 150 based on the received modification to the active joint by propagating the received modification to one or more other joints in the current keypose 230a and propagating the modifications to active joint and the one or more other joints in the current keypose 230a to neighboring poses of the current keypose 230a. In some embodiments, neighboring poses of the current keypose 230a include poses nearby the current keypose 230a bounded by a pair of adjacent keyposes 230. The animation editing application 120 then saves a modified character animation 150 that includes the modifications to the active joint and one or more other joints in the current keypose 230a and the modifications to the neighboring poses of the current keypose 230a.

At step 526, the animation editing application 120 extracts an updated plurality of trajectory datasets 160 for the plurality of joints from the modified character animation 150. At step 528, the animation editing application 120 loads an updated set of active trajectory datasets 220 corresponding to the set of active joints from the updated plurality of trajectory datasets 160. At step 530, the animation editing application 120 displays an updated representation of each updated active trajectory dataset 220 in the 3D timeline UI 130. At step 532, the animation editing application 120 automatically extracts/identifies an updated set of keyposes 162 from the modified character animation 150 based on the updated set of active trajectory datasets 220 and displays the identified keyposes 230 in the 3D timeline UI 130. Note that the animation editing application 120 can repeat steps 522-530 each time the user modifies a joint in the current keypose 230a. The method 500 then ends.

FIG. 6 sets forth a flow diagram of method steps for displaying visual representations of active trajectory datasets within a 3D timeline UI, according to various embodiments. Although the method steps are described in conjunction with the systems of FIGS. 1-4, persons skilled in the art will understand that the method steps can be performed in any order by any system. In some embodiments, the method 600 can be performed by the animation editing application 120 that includes the 3D timeline UI engine 110. In some embodiments, the method 600 can be performed by the animation editing application 120 whenever a technique disclosed herein displays visual representations of active trajectory datasets 220 along the animation timeline 210 in the 3D timeline UI 130.

The method 600 begins when the animation editing application 120 loads (at step 610) a set of active trajectory datasets 220 corresponding to a set of active joints from a plurality of trajectory datasets 160 stored to memory 104. Each active trajectory dataset 220 includes a set of joint positions (3D spatial coordinates) of a corresponding joint across all poses of the character in all frames of the character animation 150, whereby the set of joint positions are time ordered based on a frame number corresponding to each joint position. In some embodiments, the set of active joints comprises a plurality of active joints and the set of active trajectory datasets 220 comprises a plurality of active trajectory datasets 220.

At step 620, the animation editing application 120 generates a 3D curve representation of a current active trajectory dataset 220 included in the set of active trajectory datasets 220 for a current active joint to be displayed along the animation timeline 210 in the 3D timeline UI 130 by applying Equation 1 to the current active trajectory dataset 220.

$${\vec{x}}_{t} ( t ) = {\vec{x}}_{o} ( t ) + τ ( t - {t}_{c} ) \vec{{υ}_{h}} , \qquad ( 1 )$$

where:
t=time (in frame numbers);
t_{c}=current time/frame;
\vec{x}₀(t)=position of the joint at time t;
position of the joint=3D spatial coordinate (xyz coordinates);
\vec{x}ₜ(t)=corresponding position of \vec{x}₀(t) on the 3D curve representation;
\vec{v}ₕ=unit vector; and
τ=constant that indicates degree of scale of the timeline.

Equation 1 is applied to each position of the joint \vec{x}₀(t) across all frames (time t) to convert each 3D position of the joint to a position \vec{x}ₜ(t) on the 3D curve representation to be displayed along the animation timeline 210 in the 3D timeline UI 130. The vector \vec{v}ₕ is a unit vector that aligns with the direction of the timeline 120. In the embodiments described above, the unit vector comprises a unit vector along the x axis and the timeline 120 aligns horizontally along the x axis with time (frame numbers) increasing towards the right. In other embodiments, the unit vector can be a unit vector along the y or z axis and the animation timeline 210 can align with the y axis or z axis instead of the x axis. The constant t indicates the magnitude of the unit vector \vec{v}ₕ. The constant τ indicates a degree of scale of the animation timeline 210 and reflects the length/size of the animation timeline 210, whereby a larger value for t indicates a longer animation timeline 210 and a value of 0 for τ indicates no animation timeline 210.

With unit vector \vec{v}ₕ, the animation timeline 210 has a straight linear shape (such as in FIG. 2) which can be appropriate for short to medium length character animations 150. However, the straight linear shape of the animation timeline 210 may not be ideal for relatively longer character animations 150 as the user can find it difficult to reach keyposes far from the current keypose. In other embodiments, a variable vector in space is used instead to generate an animation timeline 210 having a different type of shape instead of a straight linear shape, such as a curved, circular, or spiral shape for visualizing the character animations 150. These different types of non-linear shapes can be more ideal for relatively longer character animations 150 and enable the user to more easily reach keyposes far from the current keypose.

At step 630, the animation editing application 120 then displays the resulting 3D curve representation for the current active trajectory dataset 220 for a current active joint along the animation timeline 210 in the 3D timeline UI 130. At step 640, the animation editing application 120 determines if an active trajectory dataset 220 remains to be processed in the set of active trajectory datasets 220. If so (at step 640—Yes), the animation editing application 120 continues at step 620 to process a next current active trajectory dataset 220 included in the set of active trajectory datasets 220. If not (at step 640—No), the method 600 ends.

FIG. 7 sets forth a flow diagram of method steps for automatically extracting a set of keyposes from a character animation, according to various embodiments. Although the method steps are described in conjunction with the systems of FIGS. 1-4, persons skilled in the art will understand that the method steps can be performed in any order by any system. In some embodiments, the method 700 can be performed by the animation editing application 120 that includes the 3D timeline UI engine 110. In some embodiments, the method 700 can be performed by the animation editing application 120 whenever a technique disclosed herein extracts a set of keyposes 162 from a character animation 150. In general, the animation editing application 120 can automatically extract a set of keyposes 162 from a character animation 150 based on one or more active trajectories corresponding to one or more active joints using the keypose extraction technique. In particular, each active trajectory includes a set of local extreme positions/points, and the set of keyposes 162 for the character animation 150 can be identified based on the sets of local extreme positions/points associated with the set of active trajectories. The set of local extreme positions are a set of local target positions to be identified and leveraged by the animation editing application 120 to extract the set of keyposes 162 from the character animation 150.

The method 700 begins when the animation editing application 120 loads (at step 710) a set of active trajectory datasets 220 corresponding to a set of active joints from a plurality of trajectory datasets 160 stored to memory 104. Each active trajectory dataset 220 includes a set of joint positions (3D spatial coordinates) of a corresponding joint across all poses of the character in all frames of the character animation 150, whereby the set of joint positions are time ordered based on a frame number corresponding to each joint position. In some embodiments, the set of active joints comprises a plurality of active joints and the set of active trajectory datasets 220 comprises a plurality of active trajectory datasets 220.

At step 720, the animation editing application 120 extracts/identifies a single keypose in the character animation 150 by applying Equations 2 and 3 to the set of active trajectory datasets 220 during a single iteration of a keypose extraction technique.

$$\begin{matrix}d ( t ) = {\sum }_{k = 0}^{N} {w}_{k} ‖ {T}_{k} ( t ) - {\overline{T}}_{k} ( t ) ‖ , & {w}_{k} = \frac{‖ {T}_{k} ( t ) ‖}{{\sum }_{i = 0}^{N - 1} ‖ {T}_{i} ( t ) ‖}\end{matrix} \qquad ( 2 )$$

$$\begin{matrix}{\overline{T}}_{k} ( t ) = α ( t ) {T}_{k} ( t ) + ( 1 - α ( t ) ) {\overline{T}}_{k} ( t ) , & α\end{matrix} ( t ) = {e}^{- \frac{{( t - {t}_{m} )}^{2}}{{δ}^{2}}} \qquad ( 3 )$$

where:
Tₖ(t)=trajectory of joint k (k=0, . . . N−1) over time (in frame numbers);
T̅ₖ(t)=smoothed form of trajectory Tₖ(t); and
wₖ=weight.

In Equations 2 and 3, an active trajectory dataset for an active joint k is represented as Tₖ(t). The smoothed version/form of trajectory Tₖ(t) is represented as T̅ₖ(t), which is generated by applying a Gaussian smoothing function on trajectory Tₖ (t), as shown in Equation 3. For each active joint/trajectory, the animation editing application 120 computes a difference between Tₖ(t) and T̅ₖ(t) as a function of time (t) by calculating the Euclidean distance between Tₖ(t) and T̅ₖ(t).

As shown in Equations 2 and 3, in each iteration, the animation editing application 120 computes a combined difference d(t) for all active trajectories/joints as a normalized weighted sum of the Euclidean differences for all active trajectories of all active joints. The Euclidean difference for an active trajectory comprises a difference between the active trajectory Tₖ(t) and the smoothed form T̅ₖ(t) of the active trajectory. The weight (wₖ) is normalized because when all weight values (wₖ) are added together, the total sum equals 1 (as indicated in the right portion of Equation 2). Thus, the combined difference d(t) comprises a normalized weighted sum of the Euclidean differences for all active trajectories/joints.

As indicated in the right portion of Equation 2, each weight (wₖ) is a ratio between a motion/movement magnitude of active joint k/trajectory k and the sum of motion/movement magnitudes from all active joints/trajectories. Thus, when multiple joints/trajectories are active, an active joint/trajectory that has a greater amount/magnitude of motion/movement within the character animation 150 (as indicated by the time-ordered joint positions in the active trajectory), will have a greater amount of weight/influence on the selection of keyposes than an active joint/trajectory that has a lesser amount/magnitude of motion/movement within the character animation 150 (as indicated by time-ordered joint positions in the active trajectory). The amount of weight/influence of each active joint/trajectory on the selection of keyposes is reflected/denoted in the weight value (wₖ) that is computed for the active joint/trajectory.

The function d(t) is a function of time, and at each iteration, the animation editing application 120 finds the maximum d(tₘ) at time tₘ. As shown in Equations 2 and 3, in each iteration, to find a local extreme position/point of an active trajectory, the animation editing application 120 selects the time tₘ with the largest difference d(tₘ) among all poses/frames of the character animation 150. At each iteration, a selected time tₘ is added to a list of selected positions/points, the selected time tₘ being specified by a corresponding frame number. The frame number for a selected time tₘ comprises a frame number for an identified keypose of the character animation 150. Thus, the list of selected positions/points can comprise a list of frame numbers identifying the set of keyposes 162.

At step 730, after a frame number tₘ for an identified keypose is added to the set of keyposes 162 in the current iteration, the animation editing application 120 updates the smoothed form T̅ₖ(t) for the next iteration of the keypose extraction technique, in accordance with Equation 3. In general, the smoothed form T̅ₖ(t) is updated by computing a weighted average between Tₖ(t) and T̅ₖ(t). The weighted average is used to update the smoothed form Tₖ(t) for the next iteration to ensure that the same frame number tₘ in the current iteration is not selected in the next iteration as a keypose. In particular, the weight α(t) is a function of time (t), which has a greater weight for poses/frames closer to the selected keypose/keyframe at time tₘ within a small constant window δ. The weight α(t) in Equation 3 is computed using a Gaussian function centered at t=tₘ, so that when t=tₘ, weight α(t) is equal to 1. In the next iteration, when t=tₘ, the updated smoothed form T̅ₖ(tₘ) will be equal to Tₖ(tₘ). Thus, at the next iteration, in Equation 2, Tₖ(t)−T̅ₖ(t) at t=tₘ will equal 0, thus ensuring that frame number tₘ will not be selected in the next iteration as a keypose.

At step 740, the animation editing application 120 determines if a stop condition for the keypose extraction technique is satisfied. As the keypose extraction technique is an iterative process, a stop/end condition is implemented. In some embodiments, a stop condition is satisfied if a predetermined number of keyposes have been identified in the set of keyposes 162. Note that each iteration of the keypose extraction technique adds a keypose to the set of keyposes 162, and the keypose extraction technique repeats until a sufficient number of keyposes are identified. In some embodiments, a stop condition is satisfied if the maximum difference d(tₘ) is below a threshold difference. This condition defines the case when there is no keypose to select, such as an extreme case when d(t) is a constant function of 0, so that there is no maxima position/point to select as a keypose. Thus, a lower bound of the maximum difference d(tₘ) can be defined as a threshold difference.

If a stop condition is not satisfied (at step 740—No), the animation editing application 120 continues with a next iteration at step 720. If a stop condition is satisfied (at step 740—Yes), at step 750, the animation editing application 120 stores the list of frame numbers identifying keyposes as the set of keyposes 162 in memory 104. In some embodiments, the animation editing application 120 can also retrieve, from each keyframe that includes a keypose, the metadata needed for rendering and displaying each keypose and store to the set of keyposes 162. At step 760, the animation editing application 120 displays each keypose in the set of keyposes 162 in the 3D timeline UI 130. The method 700 then ends.

In this manner, the method 700 can automatically extract a set of keyposes 162 from a character animation 150 based on a plurality of trajectories/joints, whereby the resulting set of keyposes 162 more accurately represents the motion of the character animation 150 than a set of keyposes 162 that are extracted based on a single trajectory/joint, since a plurality of trajectories for a plurality of joints more accurately represents the motion of the character animation 150 than a single trajectory for a single joint. Advantageously, editing a set of keyposes 162 that more accurately represents the character animation 150 can substantially reduce the overall amount of user time and effort in editing the character animation 150.

### Retiming a Segment of the Animation

In some embodiments, the animation editing application 120 enables a retiming function that can be applied to a selected segment of a character animation 150 within the 3D timeline UI 130 to slow down or speed up the motion of the character in the selected segment. As discussed above, the 3D timeline UI 130 displays a set of keyposes that are superimposed onto the animation timeline 210, each keypose being superimposed onto the animation timeline 210 at the frame number corresponding to the particular keypose. The user can select a segment of the character animation by selecting a pair of keyposes displayed in the 3D timeline UI, the selected pair of keyposes defining a selected segment. The user can then expand (increase) or contract (decrease) the frame distance along the animation timeline 210 between the selected pair of keyposes to slow down or speed up, respectively, the motion of the character in the selected segment. In response to the expanding or contracting of the selected segment, the animation editing application automatically executes one or more retiming operations on the selected segment based on a degree of the expansion or contraction of the selected segment along the timeline.

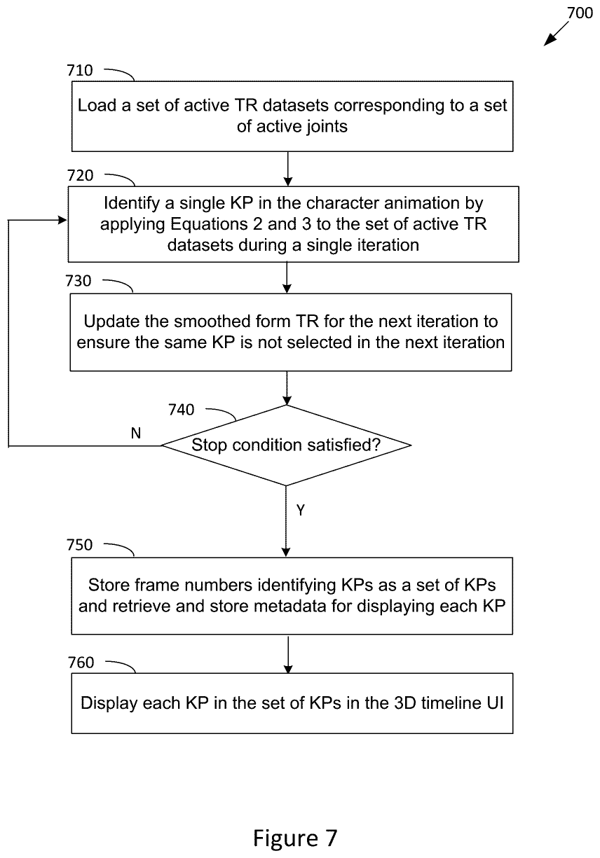

FIG. 8 is a screenshot of the 3D timeline UI of FIG. 1 showing a retiming function element, according to various embodiments. The 3D timeline UI 130 is generated based on a humanoid character of a character animation 150 that depicts the motion of the humanoid character while jumping. As shown, the 3D timeline UI 130 displays a animation timeline 210, one or more curve representations of active trajectories 820 (such as 820a and 820b) for one or more active joints of the character, one or more displayed keyposes 830 (such as 830a, 830b, 830c, etc.) extracted from the character animation 150, and a selectable retiming button 840. In some embodiments, the animation timeline 210, one or more curve representations of active trajectories 820, and the one or more keyposes 830 are simultaneously displayed in the 3D timeline UI 130 concurrently at overlapping times.

The animation timeline 210 includes a time axis having frame numbers as time units. In some embodiments, the animation timeline 210 displays a frame number for each keypose 230 along the animation timeline 210 (such as a frame number within a selectable button) and does not display a frame number for any non-keypose along the animation timeline 210. The keyposes 830 of the character are superimposed onto the animation timeline 210 and displayed along the animation timeline 210 based on the frame numbers of the animation timeline 210 and the frame numbers associated with the keyposes 830. In particular, each keypose 830 is displayed along the animation timeline 210 at a frame number corresponding to a frame in the character animation 150 that includes the keypose 830. As shown, the displayed keyposes 830 include a current keypose 830a, a pair of adjacent keyposes (keypose 830b and keypose 830c) that are keyposes adjacent to the current keypose 830 on both sides of the current keypose 830 on the animation timeline 210, and a pair of next adjacent keyposes (keypose 830d and keypose 830e) that are next adjacent keyposes to the current keypose 830 on both sides of the current keypose 830 on the animation timeline 210.

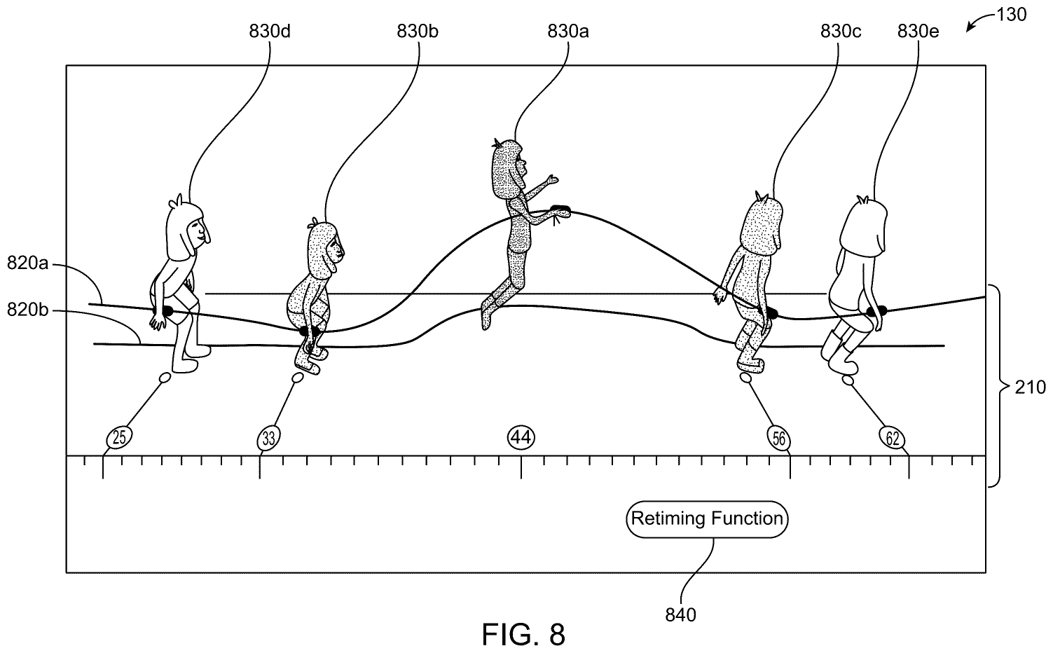

FIG. 9 is a screenshot of the 3D timeline UI of FIG. 8 showing an activated retiming function element, according to various other embodiments. User selection of the selectable retiming button 840 activates the retiming function. In response to the user selection of the selectable retiming button 840, the animation editing application 120 enables the user to select a pair of keyposes 830 via the 3D timeline UI 130 (for example, using the IE controllers 176). In the example of FIGS. 9, the user has selected the pair of adjacent keyposes (keypose 830b and keypose 830c) that are keyposes adjacent to the current keypose 830 on both sides of the current keypose 830 on the animation timeline 210.

The selected pair of keyposes 830 includes a start keypose 830b and an end keypose 830c that define the selected segment. The start keypose 830b is included in a “start frame” having an initial start-frame number (such as 33) within the character animation 150 and the end keypose 830c is included in an “end frame” having an initial end-frame number (such as 56) within the character animation 150, the initial end-frame number being higher than the initial start-frame number. Note that the “start frame” and “end frame” in this context do not refer to the start frame and end frame of the character animation 150 but refer to the start frame and end frame of the selected segment. The user can then expand (increase) or contract (decrease) the selected initial segment along the animation timeline 210 to slow down or speed up, respectively, the motion of the character within the selected initial segment. The user can do so by expanding (increasing) or contracting (decreasing) the frame distance between the selected pair of keyposes along the animation timeline 210 to specify an updated segment having an updated start-frame number, an updated end-frame number, and an updated start-frame number. The updated segment is a target segment that the user wishes to achieve with the retiming of the selected segment. The animation editing application 120 then automatically executes one or more retiming operations on the selected segment to achieve the updated segment.

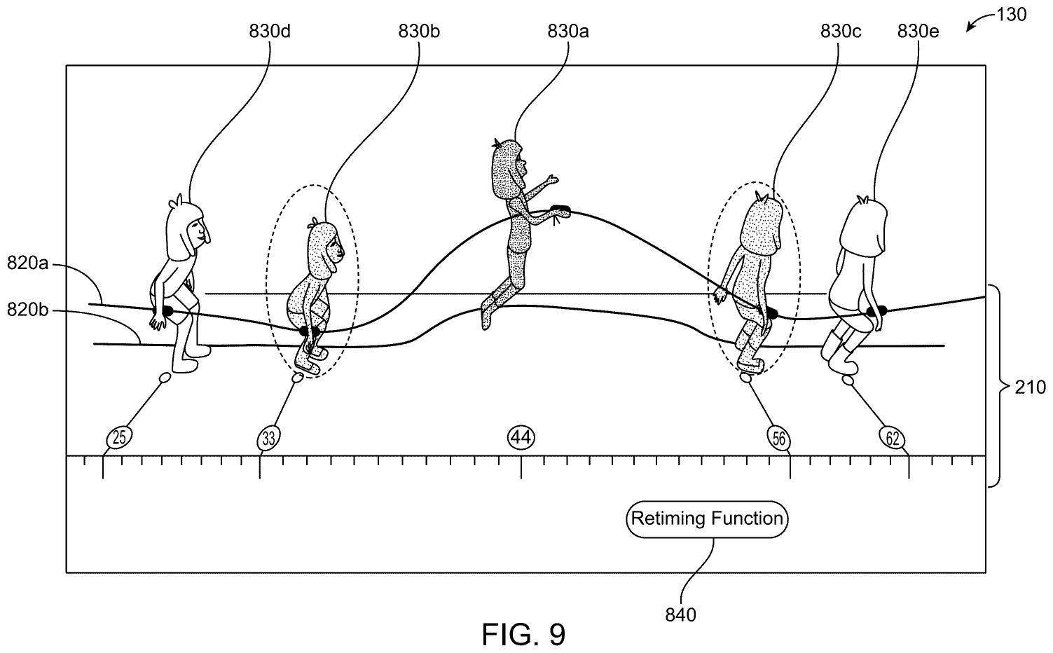

FIG. 10 is a screenshot of the 3D timeline UI of FIG. 9 showing an expanded segment, according to various other embodiments. As shown, the selected initial segment has been expanded by the user to specify an expanded updated segment. The user can do so by expanding (increasing) the frame distance along the animation timeline 210 between the selected pair of keyposes 830 by moving the selected pair of keyposes 830 outwards from their initial respective positions on the animation timeline 210 (i.e., move each keypose in the selected pair of keyposes 830 away from a center pose that is in the middle between the selected pair of keyposes 830 along the animation timeline 210). Expanding the selected initial segment along the animation timeline 210 specifies an expanded updated segment that is defined by the start keypose 830b having an updated start-frame number (such as 30) and the end keypose 830c having an updated end-frame number (such as 59), the updated end-frame number being higher than the updated start-frame number.

The selected initial segment has an initial frame distance 1010 that is equal to a difference between the initial end-frame number and the initial start-frame number (i.e., the initial end-frame number minus the initial start-frame number). The expanded updated segment has an updated frame distance 1020 that is equal to a difference between the updated end-frame number and the updated start-frame number (i.e., the updated end-frame number minus the updated start-frame number). In the example of FIG. 10, the selected initial segment has an initial start-frame number that equals 33, an initial end-frame number that equals 56, and an initial frame distance 1010 that equals 23 (56 minus 33). In the example of FIG. 10, the expanded updated segment has an updated start-frame number that equals 30, an updated end-frame number that equals 59, and an updated frame distance 1020 that equals 29 (59 minus 30). In some embodiments, the expanded updated segment includes and encompasses the selected initial segment, whereby the selected initial segment is a sub-portion of the expanded updated segment.

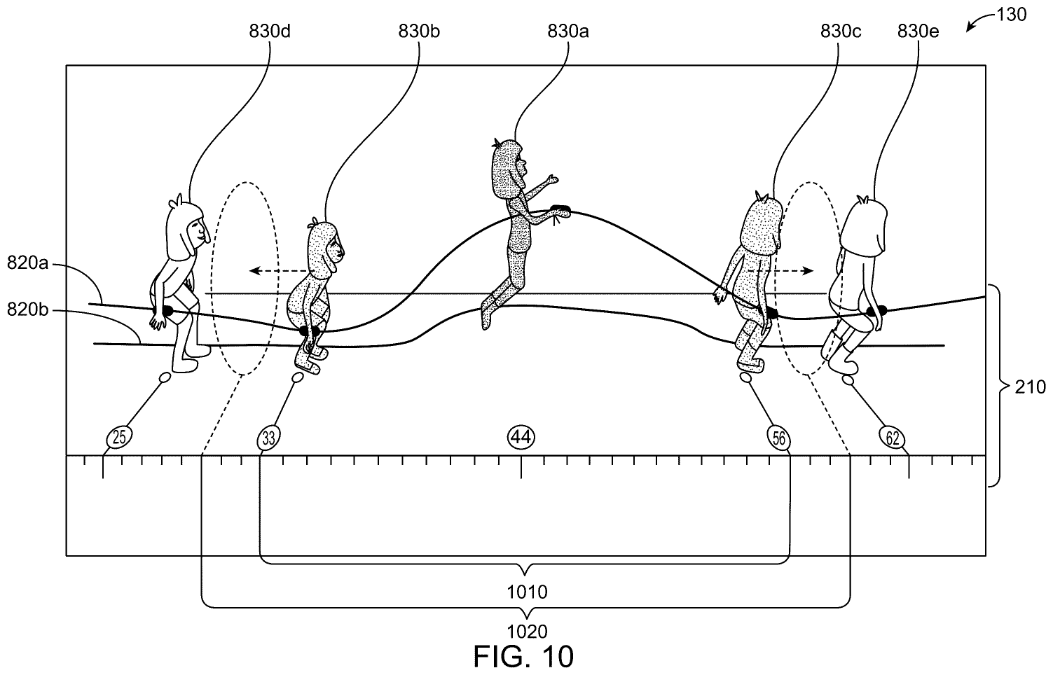

FIG. 11 is a screenshot of the 3D timeline UI of FIG. 9 showing a contracted segment, according to various other embodiments. As shown, the selected initial segment has been contracted by the user to specify a contracted updated segment. The user can do so by contracting (decreasing) the frame distance along the animation timeline 210 between the selected pair of keyposes 830 by moving the selected pair of keyposes 830 inwards from their initial respective positions on the animation timeline 210 (i.e., move each keypose in the selected pair of keyposes 830 towards a center pose that is in the middle between the selected pair of keyposes 830 along the animation timeline 210). Contracting the selected initial segment along the animation timeline 210 specifies a contracted updated segment that is defined by the start keypose 830b having an updated start-frame number (such as 37) and the end keypose 830c having an updated end-frame number (such as 52), the updated end-frame number being higher than the updated start-frame number.

The selected initial segment has an initial frame distance 1010 that is equal to a difference between the initial end-frame number and the initial start-frame number. The contracted updated segment has an updated frame distance 1120 that is equal to a difference between the updated end-frame number and the updated start-frame number. In the example of FIG. 11, the selected initial segment has an initial start-frame number that equals 33, an initial end-frame number that equals 56, and an initial frame distance 1010 that equals 23 (56 minus 33). In the example of FIG. 11, the contracted updated segment has an updated start-frame number that equals 37, an updated end-frame number that equals 52, and an updated frame distance 1120 that equals 15 (52 minus 37). In some embodiments, the selected initial segment includes and encompasses the contracted updated segment, whereby the contracted updated segment is a sub-portion of the selected initial segment.

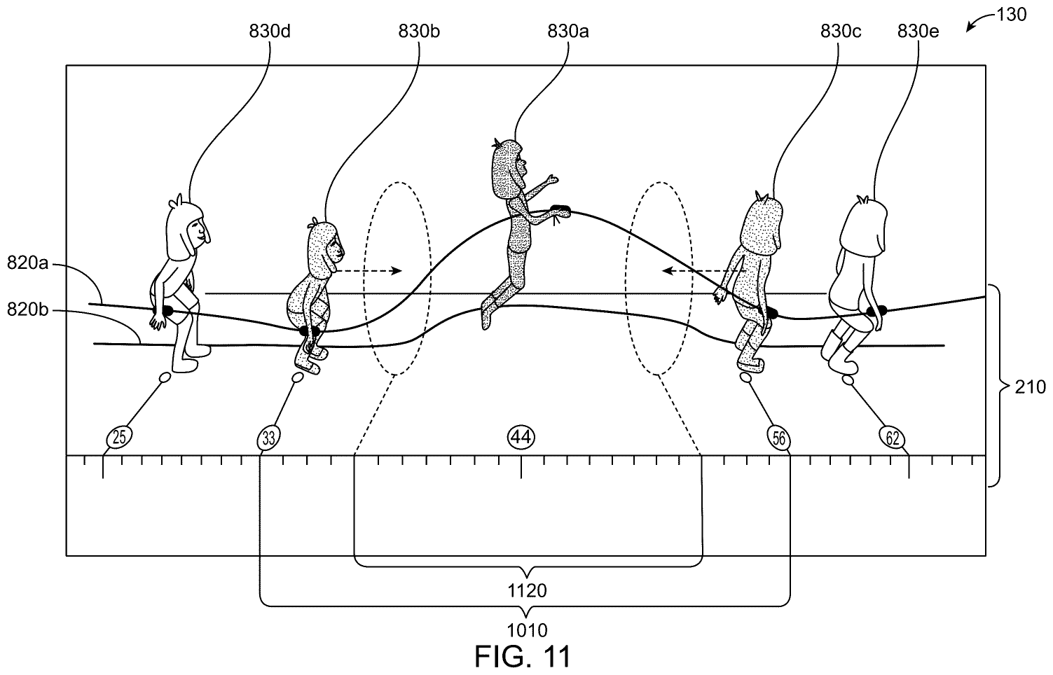

In response to receiving the expanded or contracted updated segment, the animation editing application 120 automatically executes one or more retiming operations on the selected initial segment to achieve the expanded or contracted updated segment. In some embodiments, in response to receiving the updated segment, the animation editing application 120 automatically executes one or more retiming operations on the selected initial segment based on a degree of the expansion or contraction of the selected initial segment along the animation timeline 210 using a retiming technique described below in relation to FIG. 12 and Equation 4. In particular, the animation editing application 120 automatically generates a retiming ratio based on the amount of expansion or contraction and then generates a speed curve function based on the retiming ratio. The retiming ratio equals the ratio between the initial frame distance and the updated frame distance (initial frame distance divided by the updated frame distance), whereby a retiming ratio of less than 1 indicates an expansion (slow down) and a retiming ratio of greater than 1 indicates a contraction (speed up). The speed curve function is then automatically applied to the poses/frames of the selected segment to provide a smooth and natural motion of the character in the selected segment. In particular, the speed curve function is automatically applied to all poses/frames of the character animation 150 that are between the selected pair of keyposes 830 to generate the updated segment comprising a retimed segment.

In the example of FIG. 10, the selected initial segment is expanded to generate an expanded updated segment. Thus, the retiming ratio (initial frame distance divided by the updated frame distance) is less than 1 (23 divided by 29). In this case, the animation editing application 120 automatically generates new poses/frames to add to the selected segment to achieve the expanded updated segment to slow down the motion of the character within the selected segment. In particular, the animation editing application 120 will automatically generate and add a number of new poses/frames needed to increase the initial frame distance of the selected initial segment to reach/achieve the updated frame distance of the expanded updated segment. In the example of FIG. 10, the animation editing application 120 can generate and add 6 new poses/frames to increase the initial frame distance of 23 for the selected initial segment to reach/achieve the updated frame distance of 29 for the expanded updated segment. In addition, the speed curve function indicates where in the selected segment the new poses/frames are to be added. In some embodiments, the speed curve function indicates that relatively fewer new poses/frames are to be added near the selected pair of keyposes 830 and relatively more new poses/frames are to be added towards a middle of the pair of keyposes 830 (i.e., towards a center pose that is in the middle between the selected pair of keyposes 830).

In the example of FIG. 11, the selected initial segment is contracted to generate a contracted updated segment. Thus, the retiming ratio (initial frame distance divided by the updated frame distance) is greater than 1 (23 divided by 15). In this case, the animation editing application 120 automatically removes poses/frames from the selected segment to achieve the contracted updated segment to speed up the motion of the character within the selected segment. In particular, the animation editing application 120 will automatically remove a number of poses/frames from the selected segment needed to decrease the initial frame distance of the selected initial segment to reach/achieve the updated frame distance of the contracted updated segment. In the example of FIG. 11, the animation editing application 120 can remove 8 poses/frames to decrease the initial frame distance of 23 for the selected initial segment to reach/achieve the updated frame distance of 15 for the contracted updated segment. In addition, the speed curve function indicates where in the selected segment the poses/frames are to be removed. In some embodiments, the speed curve function indicates that relatively fewer poses/frames are to be removed near the selected pair of keyposes 830 and relatively more poses/frames are to be removed towards a middle of the pair of keyposes 830 (i.e., towards a center pose that is in the middle between the selected pair of keyposes 830).

FIG. 12 sets forth a flow diagram of method steps for retiming a selected segment of a character animation, according to various embodiments. Although the method steps are described in conjunction with the systems of FIGS. 1-4 and 8-11, persons skilled in the art will understand that the method steps can be performed in any order by any system. In some embodiments, the method 1200 can be performed by the animation editing application 120 that includes the 3D timeline UI engine 110 and the retiming engine 140. Note that the retiming method 1200 can be executed at any time during the method 500 for editing a character animation via the 3D timeline UI discussed above in relation to FIGS. 5A-5B.

The method 1200 begins when the animation editing application 120 receives (at step 1210) an activation of the retiming function via the retiming button 840 of the 3D timeline UI 130 for a character animation 150. At step 1220, the animation editing application 120 receives a selection of a pair of keyposes 830 of the character animation 150 displayed on the animation timeline 210 of the 3D timeline UI 130. The selected pair of keyposes 830 includes a start keypose 830b and an end keypose 830c that define a selected initial segment of the character animation 150 for retiming operations. At step 1230, the animation editing application 120 determines information for the selected initial segment, including the initial start-frame number, initial end-frame number, and the initial frame distance. In this regard, the start keypose 830b is included in a start frame having an initial start-frame number within the character animation 150 and the end keypose 830c is included in an end frame having an initial end-frame number within the character animation 150. The selected initial segment has an initial frame distance 1010 that is equal to a difference between the initial end-frame number and the initial start-frame number.

At step 1240, the animation editing application 120 receives a selection for an updated segment from the user via an expansion or contraction of the selected initial segment along the animation timeline 210 by the user expanding (increasing) or contracting (decreasing) the frame distance between the selected pair of keyposes along the animation timeline 210, for example via the IE controllers 176. At step 1250, the animation editing application 120 determines information for the updated segment, including the updated start-frame number, updated end-frame number, and the updated frame distance that is equal to a difference between the updated end-frame number and the updated start-frame number.

At step 1260, the animation editing application 120 computes a retiming ratio comprising a ratio between the initial frame distance and the updated frame distance (initial frame distance divided by the updated frame distance). A retiming ratio of less than 1 indicates an expansion of the initial segment for slowing down the motion of the character in the character animation 150. A retiming ratio of greater than 1 indicates a contraction of the initial segment for speeding up the motion of the character in the character animation 150. Note that a retiming ratio equal to 1 indicates no change in the initial segment.

At step 1270, the animation editing application 120 computes a speed curve function Speed(t) based on the retiming ratio. Note that when there is no expansion or contraction of the selected segment, the speed curve is a function of constant 1, so that Speed(t)=1. The speed curve function defines a speed pattern of the motion of the character that is to be achieved in the updated segment. In general, the motion of a character can appear unnatural for some activities (such as jumping) if the speed of the motion is constant. In some embodiments, the speed curve function varies the speed of the motion within the updated segment to give the motion a smoother and more natural motion. For example, the speed curve function can enable an “ease-in-out” effect where the motion in the animation begins slowly, accelerates midway, and decelerates in the end. In some embodiments, the speed curve function is a delta curve that is calculated using a Quadratic Bezier curve as represented by Equation 4:

$$P ( t ) = ( {( 1 - t )}^{2} {P}_{1} + 2 ( 1 - t ) t {P}_{2} + {t}^{2} {P}_{3} ) * r ( 0 \leq t \leq 1 ) \qquad ( 4 )$$

where:
t=time;
P(t)=speed at time (t); and
r=retiming ratio.

As shown in Equation 4, the speed curve function indicates a speed value P(t) that varies with time (t) through the updated segment. The retiming ratio r specifies a magnitude of the delta curve. Note that in Equation 4, time=0 represents a start pose/frame of the updated segment and time=1 represents an end pose/frame of the updated segment.

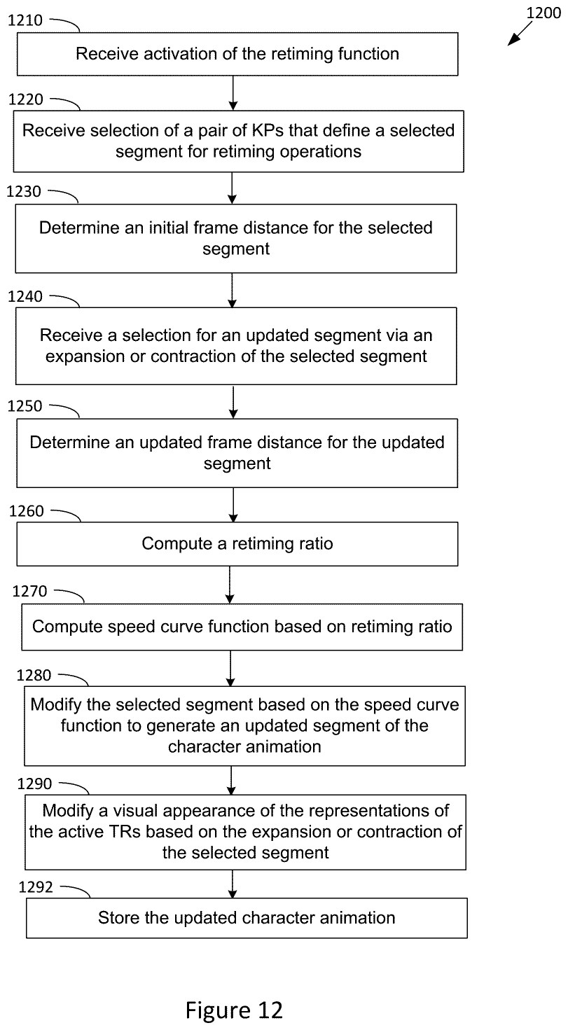

FIG. 13 illustrates a speed curve for an expanded updated segment implemented via a retiming function, according to various embodiments. As shown, an expanded speed curve 1310 for an expanded updated segment will have a magnitude less than 1. In this regard, a retiming ratio of less than 1 indicates an expansion of the initial segment that generates an expanded updated segment for slowing down the motion in the character animation 150. For a retiming ratio of less than 1, the magnitude of the speed curve will be less than 1 and always be greater than 0.

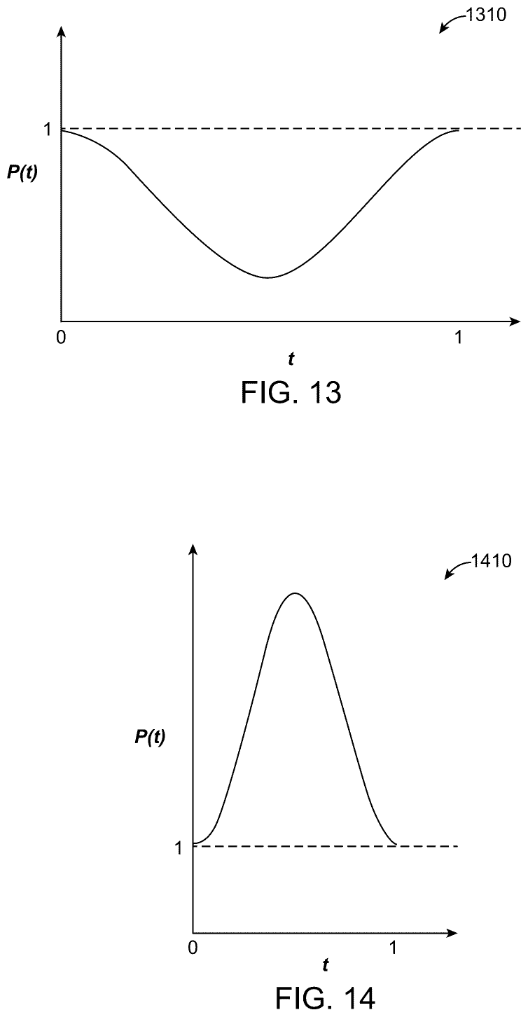

FIG. 14 illustrates a speed curve for a contracted updated segment implemented via a retiming function, according to various embodiments. As shown, a contracted speed curve 1410 for a contracted updated segment will have a magnitude greater than 1. In this regard, a retiming ratio of greater than 1 indicates a contraction of the initial segment that generates a contracted updated segment for speeding up the motion in the character animation 150. For a retiming ratio of greater than 1, the magnitude of the speed curve will be greater than 1.

At step 1280, the animation editing application 120 modifies the selected segment of the character animation 150 based on the speed curve function to generate an updated segment of the character animation 150 comprising a retimed selected segment. In particular, the speed curve function is automatically applied to the poses/frames of the character animation 150 that are between the selected pair of keyposes 830 to generate a retimed segment. Note that at step 1270, the animation editing application 120 computes a speed curve function of a motion of the character that is to be achieved by the updated segment. The speed curve function is then applied to the selected segment at step 1280 to add or remove poses/frames from the selected segment based on the speed curve function in order to achieve the desired updated segment having the speed curve function computed at step 1270. Thus, the resulting updated segment comprises a retimed version of the selected segment.

At step 1280, for an expanded updated segment, the animation editing application 120 modifies the selected segment by generating and adding a number of new poses/frames needed to increase the initial frame distance of the selected initial segment to reach/achieve the updated frame distance of the expanded updated segment (as shown in the example of FIG. 10). Thus, the expanded updated segment will have a greater number of poses/frames compared to the selected segment. To generate the new poses/frames, the animation editing application 120 can implement, for example, interpolation techniques to generate new poses/frames between the current poses/frames of the selected segment. Various frame interpolation techniques for generating new frames between existing frames can be used, such as motion estimation, blending, morphing, and the like. In other embodiments, the animation editing application 120 implements other techniques to generate the new poses/frames for adding to the selected segment. In other embodiments, animation editing application 120 leverages the animation services of the animation server 190 to generate the new poses/frames for adding to the selected segment.

In addition, the expanded speed curve function 1310 indicates to the animation editing application 120 where in the selected segment the new poses/frames are to be generated and added. As shown in FIG. 13, the expanded speed curve 1310 for an expanded updated segment indicates that the speed is relatively greater at the start and end of the updated segment near the selected pair of keyposes 830 (thus requiring relatively fewer poses/frames) than towards the middle of the updated segment having a relatively lesser speed (thus requiring relatively more poses/frames). Thus, the expanded speed curve function 1310 indicates that more of the new poses/frames should be added towards the middle of the selected segment and, in comparison, fewer of the new poses/frames should be added towards the start and end of the selected segment to achieve the desired updated segment.

At step 1280, for a contracted updated segment, the animation editing application 120 modifies the selected segment by removing a number of poses/frames from the selected segment to achieve the updated frame distance of the contracted updated segment (as shown in the example of FIG. 11) to speed up the motion of the character within the selected segment. Thus, the selected segment will have a greater number of poses/frames compared to the contracted updated segment. In addition, the contracted speed curve function 1410 indicates to the animation editing application 120 where in the selected segment the poses/frames are to be removed. As shown in FIG. 14, the contracted speed curve 1410 for a contracted updated segment indicates that the speed is relatively less at the start and end of the updated segment near the selected pair of keyposes 830 (thus requiring relatively more poses/frames) than towards the middle of the updated segment having a relatively greater speed (thus requiring relatively fewer poses/frames). Thus, the contracted speed curve function 1410 indicates that more of the poses/frames removed towards the middle of the selected segment and, in comparison, fewer of the poses/frames should be removed towards the start and end of the selected segment to achieve the desired updated segment.

At step 1290, as an optional step, the animation editing application 120 modifies a visual appearance (such as color) of the curve representations of each active trajectory dataset 220 displayed in the 3D timeline UI 130 based on the expansion or contraction of the selected segment. In these embodiments, the representations of the active trajectory datasets 820 (such as 820a and 820b) can initially be displayed in a first color (such as yellow) before the selected initial segment is selected by the user. After the selected initial segment is retimed to generate the updated segment, the representations of the active trajectory datasets 820 can be updated to display in a second color that is different from the first color to indicate the retiming of the selected segment. In some embodiments, the color change to the second color can be limited to the portion of the curve representations of the active trajectory datasets 820 that are included within the updated segment, whereby the remainder of the curve representations of the active trajectory datasets 820 for the remainer of the character animation 150 remain in the first color. In some embodiments, for an expanded updated segment, the second color is red, to indicate a slow down of the motion in the selected segment. In some embodiments, for a contracted updated segment, the second color is green, to indicate a speed up of the motion in the selected segment.

In some embodiments, the second color can have a different appearance (such as different levels of hue, tint, hue, shading, etc.) based on an amount/degree of expansion or contraction of the selected segment. In these embodiments, the second color can have a different appearance based on the retiming ratio, which indicates an amount/degree of expansion or contraction of the selected segment. For example, for an expanded updated segment, a retiming ratio (which will be less than 1) that is lesser in value indicates a greater amount/degree of expansion of the selected segment than a retiming ratio that is greater in value. Thus, for example, the second color can have relatively greater shade levels of red for relatively lower values of the retiming ratio for an expanded updated segment. For example, for a contracted updated segment, a retiming ratio (which will be greater than 1) that is greater in value indicates a greater amount/degree of contraction of the selected segment than a retiming ratio that is lesser in value. Thus, for example, the second color can have relatively greater shade levels of green for relatively greater values of the retiming ratio for a contracted updated segment.

At step 1292, the animation editing application 120 stores the character animation 150 with the updated segment (retimed segment) as an updated character animation 150. The method 1200 then ends.

In sum, the disclosed techniques enable a 3D timeline UI in an animation editing application to integrate spatial controls and temporal controls for editing a character animation of a character. A character animation comprises a set of frames including motion capture data that specifies 3D models for a set of poses of the character, each frame including a particular pose of the character. The character includes a set of joints that are included in the 3D models for the set of poses of the character. The set of poses includes a set of non-essential poses and a set of keyposes that is representative of the motion of the character in the character animation. The 3D timeline UI displays a timeline comprising a time axis having frame numbers as time units. The 3D timeline UI also displays 3D models for the set of keyposes that are superimposed/overlaid onto the timeline, each 3D model for a particular keypose being superimposed/overlaid onto the timeline at the frame number corresponding to the frame that includes the particular keypose. The 3D timeline UI also displays a set of trajectories that are superimposed/overlaid onto the set of keyposes based on a set of joints of the character. Each displayed trajectory comprises a 3D curve that passes through a particular joint of the character across the set of keyposes to help users visualize the passage of time and the motion of the character that occurs in the poses between the keyposes.

The user can directly edit a 3D model for a current keypose displayed in the 3D timeline UI by modifying the position and/or rotation of at least one joint of the 3D model for the current keypose. In response, the 3D timeline UI automatically propagates corresponding changes to the 3D models of one or more poses nearby the current keypose and automatically updates the set of trajectories based on the changes to the current keypose and the nearby poses. The 3D timeline UI also automatically displays the updated set of trajectories to indicate the changes to the current keypose and the nearby poses to help users visualize the updated motion of the character that occurs in the poses between the keyposes. The changes to the current keypose and the nearby poses generate a modified character animation that can be stored and further modified based on user edits.

At least one technical advantage of the disclosed techniques relative to the prior art is that the disclosed techniques enable spatial controls and temporal controls for editing character animations to be integrated and located together within a 3D timeline user interface (UI) of an animation editing application. The 3D timeline UI simultaneously displays a set of keyposes and a set of trajectories that are superimposed onto an animation timeline. Each displayed trajectory passes through a particular joint of a character across the set of keyposes to help users visualize the character motion that occurs in the different poses that occur between the keyposes. The user can modify a current keypose displayed along the animation timeline and, in response, the 3D timeline UI automatically propagates corresponding changes to the poses located near the keypose and indicates the corresponding changes via an updated set of trajectories that help users visualize the modified motion of the character along the animation timeline. With this functionality, the 3D timeline UI simplifies animation editing for non-expert users relative to prior art approaches by not requiring the user to continually alternate between the spatial controls/view of the poses and the temporal controls/view of the animation timeline to modify the motion of the character animation. In addition, when changes are made to a current keypose, the 3D timeline UI automatically indicates resulting changes made to nearby poses via the updated trajectories so that users do not have to accurately predict how changes to one pose impact nearby poses, as required in prior art approaches. In this manner, the disclosed techniques provide an approachable and intuitive interface that enables non-expert users to more easily and efficiently edit character animations relative to conventional editing applications. These technical advantages provide one or more technological improvements over prior art approaches.

In sum, the disclosed techniques enable an animation editing application to automatically extract a set of keyposes from a character animation, the set of keyposes being representative of the motion of the character in the character animation. The set of keyposes are automatically extracted from the character animation based on one or more joint trajectories associated with the character animation. The animation editing application initially generates a trajectory for each joint of the character. A trajectory for a particular joint comprises a dataset comprising a set of ordered positions of the particular joint across all poses in all frames of the character animation. The set of positions of the trajectory are ordered based on frame numbers (time) corresponding to the set of positions. For example, a first trajectory can comprise a first set of positions for a right ankle joint of the character that specify 3D spatial coordinates for the right ankle joint for each pose in each frame of the character animation. The first set of positions can be sequentially ordered based on frame number (time). The animation editing application can generate and store a trajectory for each joint of the character, such as 10 trajectories corresponding to 10 joints of the character.

The animation editing application then receives a user selection of a plurality of active joints of the character and retrieves a plurality of active trajectories corresponding to the plurality of active joints. In other embodiments, a default plurality of active joints is selected by the animation editing application. The animation editing application then extracts the set of keyposes from the character animation based on the plurality of active trajectories. In particular, each active trajectory includes a set of local extreme positions/points, and the set of keyposes for the character animation are identified based on the sets of local extreme positions/points associated with the plurality of active trajectories. The set of local extreme positions are a set of local target positions to be identified and leveraged by the animation editing application 120 to extract the set of keyposes 162 from the character animation 150. The user can also select a new plurality of active joints of the character, which causes the animation editing application to dynamically identify a new set of keyposes for the character animation based on the new plurality of active joints. The animation editing application displays the set of keyposes, whereby the user can select and directly edit a keypose among the set of keyposes to modify the character animation.

At least one technical advantage of the disclosed techniques relative to the prior art is that the disclosed techniques enable an animation editing application to automatically and accurately extract a set of keyposes from a character animation, something that was not achievable using prior art approaches. Accordingly, the disclosed techniques avoid a non-expert user inaccurately selecting a set of keyposes from the character animation. In particular, the disclosed techniques enable the animation editing application to extract a set of keyposes that accurately represents the motion of the character animation based on the trajectories of multiple joints of the character through the various poses of the character animation. Automatically identifying and extracting a set of keyposes that accurately represents a character animation can also increase the overall accuracy and quality of the edits made to the character animation. These technical advantages provide one or more technological improvements over prior art approaches.

In sum, the disclosed techniques enable a retiming function in an animation editing application that is applied to a selected segment of a character animation to slow down or speed up the motion of the character in the selected segment. The user can select the segment by selecting a pair of keyposes of the character animation 150 that are displayed along the animation timeline 210 in the 3D timeline UI 130. The selected pair of keyposes includes a start keypose and an end keypose that define the selected segment. The start keypose is included in a “start frame” having an initial start-frame number within the character animation 150 and the end keypose is included in an “end frame” having an initial end-frame number within the character animation 150, the initial end-frame number being higher than the initial start-frame number. Note that the “start frame” and “end frame” in this context do not refer to the start frame and end frame of the character animation 150 but refer to the start frame and end frame of the selected segment. The selected initial segment has an initial frame distance that is equal to a difference between the initial end-frame number and the initial start-frame number (i.e., the initial end-frame number minus the initial start-frame number).

The user can then expand (increase) or contract (decrease) the selected initial segment along the animation timeline 210 to slow down or speed up, respectively, the motion of the character within the selected initial segment. The user can do so by expanding (increasing) or contracting (decreasing) the frame distance along the timeline between the selected pair of keyposes. Expanding or contracting the selected initial segment along the timeline generates an updated segment that is defined by the start keypose having an updated start-frame number and the end keypose having an updated end-frame number, the updated end-frame number being higher than the updated start-frame number. The updated segment has an updated frame distance that is equal to a difference between the updated end-frame number and the updated start-frame number (i.e., the updated end-frame number minus the updated start-frame number).

In response to receiving the updated segment, the animation editing application 120 automatically executes one or more retiming operations on the selected initial segment based on a degree of the expansion or contraction of the selected initial segment along the animation timeline 210. In particular, the animation editing application 120 automatically generates a retiming ratio based on the amount of expansion or contraction and then generates a speed curve function based on the retiming ratio. The retiming ratio equals the ratio between the initial frame distance and the updated frame distance, whereby a retiming ratio of less than 1 indicates an expansion (slow down) and a retiming ratio of greater than 1 indicates a contraction (speed up). The speed curve function is automatically applied to all poses/frames of the selected segment to provide a smooth and natural motion of the character in the selected segment.

At least one technical advantage of the disclosed techniques relative to the prior art is that the disclosed techniques enable a retiming function in an animation editing application that can be automatically applied to a selected segment of a character animation to slow down or speed up the motion of the character in the selected segment, something that was not achievable using prior art approaches. In operation, a user expands or contracts the selected segment to specify an updated segment. In response, the retiming function automatically generates a speed curve function based on the amount of expansion or contraction and applies the speed curve function to the selected segment to add new frames or remove frames from the selected segment to automatically generate an updated segment, where the character within the updated segment has a smooth and natural motion. In this manner, the disclosed techniques provide a retiming function that allows both expert and non-expert users to more accurately and efficiently retime a segment of a given character animation to improve the quality of the character animation relative to what can be achieved using prior art approaches. These technical advantages provide one or more technological improvements over prior art approaches.

Aspects of the subject matter described herein are set out in the following numbered clauses.

1. In some embodiments, a computer-implemented method for modifying character animations via a user interface comprises displaying a timeline that includes frame numbers as time units, displaying a set of keyposes of the character along the timeline based on a set of frame numbers associated with the set of keyposes, displaying a set of trajectories that is superimposed on the set of keyposes, wherein each trajectory in the set of trajectories is displayed as a curve that passes through a particular joint of the character across the set of keyposes, and receiving a modification of a first keypose included in the set of keyposes via the user interface.

2. The computer-implemented method of clause 1, further comprising in response to receiving the modification, modifying a set of neighboring poses of the first keypose in the character animation based on the modification of the first keypose, wherein the set of neighboring poses is bound by a pair of keyposes in the set of keyposes.

3. The computer-implemented method of clauses 1 or 2, wherein the one keypose included in the pair of keyposes is adjacent to the first keypose on a first side of the first keypose, and a another keypose included in the pair of keyposes is adjust to the first keypose on a second side of the first keypose.

4. The computer-implemented method of any of clauses 1-3, wherein each keypose in the pair of keyposes are selected by a user.

5. The computer-implemented method of any of clauses 1-4, further comprising receiving a selection of a first keypose in the set of keyposes via the user interface, and in response, displaying a selectable element on a first joint associated with the first keypose in the set of keyposes, wherein the selectable element is selectable for modifying a position or rotation of the first joint.

6. The computer-implemented method of any of clauses 1-5, further comprising receiving a modification of a first keypose in the set of keyposes via the user interface, modifying the character animation based on the modification of the first keypose to generate a modified character animation, and displaying an updated set of keyposes and an updated set of trajectories based on the modified character animation.

7. The computer-implemented method of any of clauses 1-6, wherein receiving the modification of the first keypose includes receiving a modification of a position or rotation of a first joint associated with the first keypose.

8. The computer-implemented method of any of clauses 1-7, wherein displaying the set of keyposes of the character comprises displaying a three-dimensional (3D) model of the character for each keypose in the set of keyposes along the timeline.

9. The computer-implemented method of any of clauses 1-8, wherein the user interface comprises a three-dimensional immersive environment interface.

10. The computer-implemented method of any of clauses 1-9, wherein the immersive environment interface comprises a virtual-reality interface or an augmented-reality interface.

11. In some embodiments, one or more non-transitory computer-readable media include instructions that, when executed by one or more processors, cause the one or more processors to modifying character animations via a user interface by performing the steps of displaying a timeline that includes frame numbers as time units, displaying a set of keyposes of the character along the timeline based on a set of frame numbers associated with the set of keyposes, displaying a set of trajectories that is superimposed on the set of keyposes, wherein each trajectory in the set of trajectories is displayed as a curve that passes through a particular joint of the character across the set of keyposes, and receiving a modification of a first keypose included in the set of keyposes via the user interface.

12. The one or more non-transitory computer-readable media of clause 11, further comprising in response to receiving the modification, modifying a set of neighboring poses of the first keypose in the character animation based on the modification of the first keypose, wherein the set of neighboring poses is bound by a pair of keyposes in the set of keyposes.

13. The one or more non-transitory computer-readable media of clauses 11 or 12, wherein the one keypose included in the pair of keyposes is adjacent to the first keypose on a first side of the first keypose, and a another keypose included in the pair of keyposes is adjust to the first keypose on a second side of the first keypose.

14. The one or more non-transitory computer-readable media of any of clauses 11-13, wherein each keypose in the pair of keyposes are selected by a user.

15. The one or more non-transitory computer-readable media of any of clauses 11-14, further comprising receiving a selection of a first keypose in the set of keyposes via the user interface, and in response, displaying a selectable element on a first joint associated with the first keypose in the set of keyposes, wherein the selectable element is selectable for modifying a position or rotation of the first joint.

16. The one or more non-transitory computer-readable media of any of clauses 11-15, further comprising receiving a modification of a first keypose in the set of keyposes via the user interface, modifying the character animation based on the modification of the first keypose to generate a modified character animation, and displaying an updated set of keyposes and an updated set of trajectories based on the modified character animation.

17. The one or more non-transitory computer-readable media of any of clauses 11-16, wherein the character animation includes the set of keyposes and a set of non-keyposes, wherein the timeline displays a frame number for each keypose in the set of keyposes and does not display a frame number for any non-keypose in the set of non-keyposes in the character animation.

18. The one or more non-transitory computer-readable media of any of clauses 11-17, wherein the timeline displays a selectable frame number for each keypose in the set of keyposes.

19. The one or more non-transitory computer-readable media of any of clauses 11-18, further comprising receiving a selection of a first selectable frame number on the timeline for a first keypose in the set of keyposes, and in response, navigating to the first keypose in the set of keyposes.

20. In some embodiments, a computer system comprises a memory that includes instructions, and at least one processor that is coupled to the memory and, upon executing the instructions, modify character animations via a user interface by performing the steps of displaying a timeline that includes frame numbers as time units, displaying a set of keyposes of the character along the timeline based on a set of frame numbers associated with the set of keyposes, displaying a set of trajectories that is superimposed on the set of keyposes, wherein each trajectory in the set of trajectories is displayed as a curve that passes through a particular joint of the character across the set of keyposes, and receiving a modification of a first keypose included in the set of keyposes via the user interface.

Any and all combinations of any of the claim elements recited in any of the claims and/or any elements described in this application, in any fashion, fall within the contemplated scope of the present embodiments and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUIs, etc.) are, in various embodiments, stored in the memory/memories shown in the relevant system figure(s) and executed by the processor(s) shown in those same system figures.

Any combination of one or more computer readable medium(s) can be utilized. The computer readable medium can be a computer readable signal medium or a computer readable storage medium. A computer readable storage medium can be, for example, but not limited to, an electronic, non-transitory, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for modifying character animations via a user interface, the method comprising:
displaying a timeline that includes frame numbers as time units;
displaying a set of keyposes of the character along the timeline based on a set of frame numbers associated with the set of keyposes;
displaying a set of trajectories that is superimposed on the set of keyposes, wherein each trajectory in the set of trajectories is displayed as a curve that passes through a particular joint of the character across the set of keyposes; and
receiving a modification of a first keypose included in the set of keyposes via the user interface.

2. The computer-implemented method of claim 1, further comprising:
in response to receiving the modification, modifying a set of neighboring poses of the first keypose in the character animation based on the modification of the first keypose, wherein the set of neighboring poses is bound by a pair of keyposes in the set of keyposes.

3. The computer-implemented method of claim 2, wherein the one keypose included in the pair of keyposes is adjacent to the first keypose on a first side of the first keypose, and a another keypose included in the pair of keyposes is adjust to the first keypose on a second side of the first keypose.

4. The computer-implemented method of claim 2, wherein each keypose in the pair of keyposes are selected by a user.

5. The computer-implemented method of claim 1, further comprising:
receiving a selection of a first keypose in the set of keyposes via the user interface; and
in response, displaying a selectable element on a first joint associated with the first keypose in the set of keyposes, wherein the selectable element is selectable for modifying a position or rotation of the first joint.

6. The computer-implemented method of claim 1, further comprising:
receiving a modification of a first keypose in the set of keyposes via the user interface;
modifying the character animation based on the modification of the first keypose to generate a modified character animation; and
displaying an updated set of keyposes and an updated set of trajectories based on the modified character animation.

7. The computer-implemented method of claim 6, wherein receiving the modification of the first keypose includes receiving a modification of a position or rotation of a first joint associated with the first keypose.

8. The computer-implemented method of claim 1, wherein displaying the set of keyposes of the character comprises displaying a three-dimensional (3D) model of the character for each keypose in the set of keyposes along the timeline.

9. The computer-implemented method of claim 1, wherein the user interface comprises a three-dimensional immersive environment interface.

10. The computer-implemented method of claim 9, wherein the immersive environment interface comprises a virtual-reality interface or an augmented-reality interface.

11. One or more non-transitory computer-readable media including instructions that, when executed by one or more processors, cause the one or more processors to modifying character animations via a user interface by performing the steps of:
displaying a timeline that includes frame numbers as time units;
displaying a set of keyposes of the character along the timeline based on a set of frame numbers associated with the set of keyposes;
displaying a set of trajectories that is superimposed on the set of keyposes, wherein each trajectory in the set of trajectories is displayed as a curve that passes through a particular joint of the character across the set of keyposes; and
receiving a modification of a first keypose included in the set of keyposes via the user interface.

12. The one or more non-transitory computer-readable media of claim 11, further comprising:
in response to receiving the modification, modifying a set of neighboring poses of the first keypose in the character animation based on the modification of the first keypose, wherein the set of neighboring poses is bound by a pair of keyposes in the set of keyposes.

13. The one or more non-transitory computer-readable media of claim 12, wherein the one keypose included in the pair of keyposes is adjacent to the first keypose on a first side of the first keypose, and a another keypose included in the pair of keyposes is adjust to the first keypose on a second side of the first keypose.

14. The one or more non-transitory computer-readable media of claim 12, wherein each keypose in the pair of keyposes are selected by a user.

15. The one or more non-transitory computer-readable media of claim 11, further comprising:
receiving a selection of a first keypose in the set of keyposes via the user interface; and
in response, displaying a selectable element on a first joint associated with the first keypose in the set of keyposes, wherein the selectable element is selectable for modifying a position or rotation of the first joint.

16. The one or more non-transitory computer-readable media of claim 11, further comprising:
receiving a modification of a first keypose in the set of keyposes via the user interface;
modifying the character animation based on the modification of the first keypose to generate a modified character animation; and
displaying an updated set of keyposes and an updated set of trajectories based on the modified character animation.

17. The one or more non-transitory computer-readable media of claim 11, wherein the character animation includes the set of keyposes and a set of non-keyposes, wherein the timeline displays a frame number for each keypose in the set of keyposes and does not display a frame number for any non-keypose in the set of non-keyposes in the character animation.

18. The one or more non-transitory computer-readable media of claim 11, wherein the timeline displays a selectable frame number for each keypose in the set of keyposes.

19. The one or more non-transitory computer-readable media of claim 18, further comprising:
receiving a selection of a first selectable frame number on the timeline for a first keypose in the set of keyposes; and
in response, navigating to the first keypose in the set of keyposes.

20. A computer system comprising:
a memory that includes instructions; and
at least one processor that is coupled to the memory and, upon executing the instructions, modify character animations via a user interface by performing the steps of:
displaying a timeline that includes frame numbers as time units;
displaying a set of keyposes of the character along the timeline based on a set of frame numbers associated with the set of keyposes;
displaying a set of trajectories that is superimposed on the set of keyposes, wherein each trajectory in the set of trajectories is displayed as a curve that passes through a particular joint of the character across the set of keyposes; and
receiving a modification of a first keypose included in the set of keyposes via the user interface.
